(19) United States
(12) Patent Application Publication
(10) Pub. No.: US 2026/0352392 A1
(43) Pub. Date: Nov. 5, 2026

(54) METHODS AND APPARATUSES FOR WTRU PROCESSING ADAPTATION

(71) Applicant: InterDigital Patent Holdings, Inc., Wilmington, DE (US)

(72) Inventors: Tuong Hoang, Montreal (CA); Faris Alfarhan, Montreal (CA); Samuli Turtinen, Ii (FI); Loic Canonne-Velasquez, Dorval (CA); Tao Deng, New York, NY (US); Paul Marinier, Brossard (CA); Brian Martin, Farnham (GB); Martino Freda, Laval (CA); Keiichi Kubota, Setagaya-Ku (JP); Chia-Hung Wei, Chesterbrook, PA (US); Ghyslain Pelletier, Montreal (CA)

(73) Assignee: InterDigital Patent Holdings, Inc., Wilmington, DE (US)

(21) Appl. No.: 19/199,006

(22) Filed: May 5, 2025

(51) Int. Cl. H04L 5/00; H04L 41/0803

(52) U.S. Cl. CPC H04L 5/0044; H04L 41/0803

(57) ABSTRACT

A WTRU may receive a plurality of processing configurations. Each processing configuration of the plurality of processing configurations may include at least one parameter, for example for at least one or more of uplink (UL) processing and/or downlink (DL) processing. The WTRU may operate in accordance with a first processing configuration of the plurality of processing configurations. The WTRU may determine to operate in a second processing configuration of the plurality of processing configurations, for example based on the at least one triggering condition being met. The WTRU may send an indication of the second processing configuration. The WTRU may operate in accordance with the second processing configuration of the plurality of processing configurations, for example based on a determination that the at least one triggering condition, for example associated with the second processing configuration, has been met.

### BACKGROUND

There may be power saving techniques, for example for 5G. To save power and/or wireless transmit/receive unit (WTRU) processing, several power saving techniques may be utilized, including for example bandwidth part (BWP) switching, carrier activation/de-activation, dormant cell vs. non-dormant cell switching, search-space set group (SSSG) switching, PDCCH skipping, low power-wake up signal (LP-WUS), and/or radio resource management (RRM)/radio link monitoring (RLM)/bidirectional forward detection (BFD) relaxation.

BWP switching may be utilized to save power and/or WTRU processing. Larger BWP may utilize more WTRU processing. However, larger BWP may help the WTRU to achieve a higher data rate. BWP switching may enable the WTRU to switch from one BWP to another BWP. BWP switching may be controlled by the network, for example using downlink control information (DCI) and/or radio resource control (RRC). BWP switching may enable the network to control the operation bandwidth of the WTRU. If the WTRU is to receive a large amount of data for example, a large BWP may be used. If there is not much data transmission/reception for example, a small BWP may be used.

Carrier activation/de-activation may be utilized to save power and/or WTRU processing. Multi-carrier operation may be utilized to enhance a data rate of the WTRU. However, more carriers configured may result in more WTRU power consumption. A mechanism for the network to dynamically activate/deactivate one or more component carriers using medium access control-control element (MAC-CE) may be utilized, for example in new radio (NR). Carrier activation/deactivation may be faster than RRC and/or slower than DCI. Activation/deactivation of a known carrier/cell may take more than 20 ms, which for example may not be desirable to quickly ramp up the data rate of the WTRU and/or for delay-critical services.

Dormant cell vs. non-dormant cell switch may be utilized to save power and/or WTRU processing. To minimize the carrier activation/deactivation interruption for example, there may be dormant cell (e.g., in NR). When a cell is in a dormant state for example, no active data exchange between the WTRU and the cell may be expected. The WTRU may (e.g., therefore) skip PDCCH monitoring. The WTRU may (e.g., still) measure channel state information-reference signal (CSI-RS) and/or report CSI. By performing CSI-RS measurement and/or reporting for example, the WTRU may be able to be quickly scheduled by the network when it is indicated to switch from dormant to non-dormant state via DCI.

SSSG may be utilized to save power and/or WTRU processing. Search-space set group switching may enable the network to control which SSSG the WTRU should monitor in a BWP. The mechanism may enable the network to switch the WTRU to different patterns of PDCCH monitoring, for example to save WTRU power when there is not much data activity.

Physical downlink control channel (PDCCH) skipping may be utilized to save power and/or WTRU processing. Similar to SSSG switching for example, PDCCH skipping may the enable the network to adapt the PDCCH monitoring behavior of the WTRU. If the network does not expect to have downlink data for the WTRU within a period for example, the network may indicate the WTRU to skip PDCCH monitoring for the expected period. This may help save power consumption for the WTRU.

LP-WUS may be utilized to save power and/or WTRU processing. LP-WUS may enable the WTRU to put the WTRU main radio (MR) in an inactive state, for example to save power. Low radio may consume (e.g., much) less power compared to MR. Low radio may be used to monitor LP-WUS from the network, for example for detecting wake-up signal indication from the network. This mechanism may additionally or alternatively enable the WTRU to save power by enabling the MR to be inactive.

In RRC CONNECTED mode for example, WTRU power saving gain may be obtained with marginal impact to capacity. WTRU power saving gain may be obtained by using LP-WUS/WUR to trigger WTRU MR PDCCH monitoring compared with existing WTRU power saving techniques, for example across different types of extended reality (XR) traffic and system load scenarios. In RRC IDLE/INACTIVE modes for example, WTRU power saving gain may be obtained by using LP-WUS/WUR to trigger WTRU MR paging monitoring compared with existing I-DRX operation.

RRM/RLM/BFD relaxation may be utilized to save power and/or WTRU processing. To save power for example, the WTRU may be relaxed for RRM/RLM/BFD measurement and/or reporting if the cell is in good quality and/or the WTRU is in slow mobility. Measurement relaxation may enable the WTRU to save power, for example as the WTRU may be able to reduce processing by relaxing measurement(s).

### SUMMARY

A WTRU may receive, for example from a network, configuration information. The configuration information may include a plurality of processing configurations. Each processing configuration of the plurality of processing configurations may include one or more parameters, for example for at least one or more of uplink (UL) processing and/or downlink (DL) processing. The configuration information may include one or more triggering conditions. The WTRU may operate in accordance with a first processing configuration of the plurality of processing configurations.

The WTRU may determine to operate in a second processing configuration of the plurality of processing configurations, for example based on the one or more triggering conditions being met. The one or more triggering conditions may be associated with the second processing configuration of the plurality of processing configurations. Additionally, or alternatively, the one or more triggering condition may be associated with a subset and/or each of the plurality of processing configurations. The WTRU may send an indication of the second processing configuration, for example to the network. The WTRU may operate in accordance with the second processing configuration of the plurality of processing configurations, for example based on a determination that the one or more triggering conditions has been met.

The WTRU may determine that a processing configuration of the plurality of processing configurations is a preferred processing configuration, for example based on the indication of the second processing configuration. Additionally, or alternatively, the WTRU may determine that a processing configuration of the plurality of processing configurations is a preferred processing configuration, based on at least one preferred value associated with at least one of the one or more parameters. The WTRU may send the indication of the second processing configuration to the network in at least one radio control element message. The radio control element message may be associated with at least one control element.

The one or more triggering conditions may include an amount of data in a buffer exceeding a threshold amount. The WTRU may receive an indication from the network to operate in accordance with the second processing configuration. The one or more triggering conditions may include the indication from the network to operate in accordance with the second processing configuration. The second processing configuration may be associated with a service. The WTRU may determine when data associated with the service is received. The triggering condition associated with each of the plurality of processing configurations may include reception of data associated with the service.

The first processing configuration of the plurality of processing configurations may be associated with a first quality of service and/or the second processing configuration of the plurality of processing configurations may be associated with a second quality of service. The one or more triggering conditions may include reception of data associated with the second quality of service.

The WTRU may send a request to the network to operate in accordance with the second processing configuration. The WTRU may receive a response indicating that the WTRU should operate in accordance with the second processing configuration. The WTRU may operate in accordance with a third processing configuration, for example based on the one or more triggering conditions. The WTRU may switch from a first carrier to a second carrier to operate in the third processing configuration.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of a WTRU switch of a configuration based on a triggering condition.

FIG. 3 is an example of a WTRU adapting a configuration across a plurality of carriers.

### DETAILED DESCRIPTION

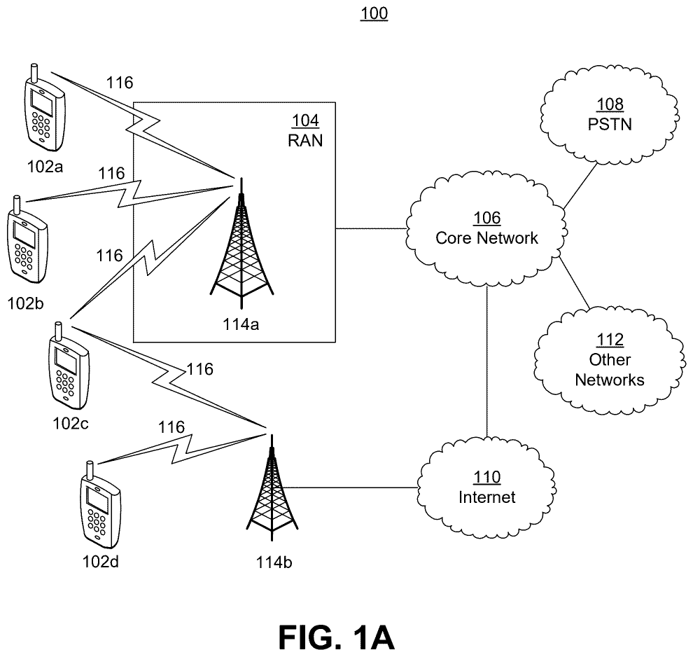

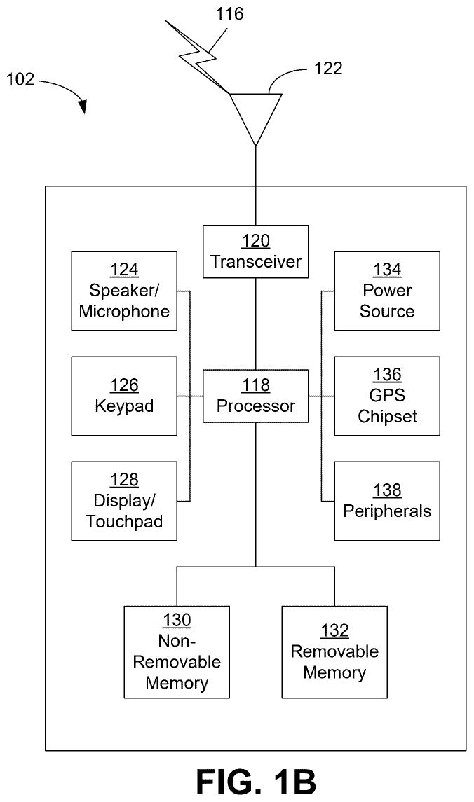

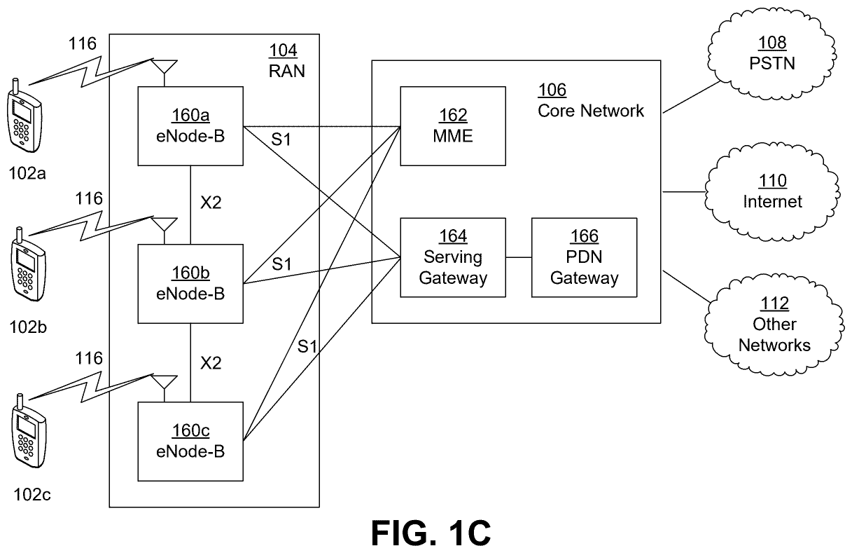

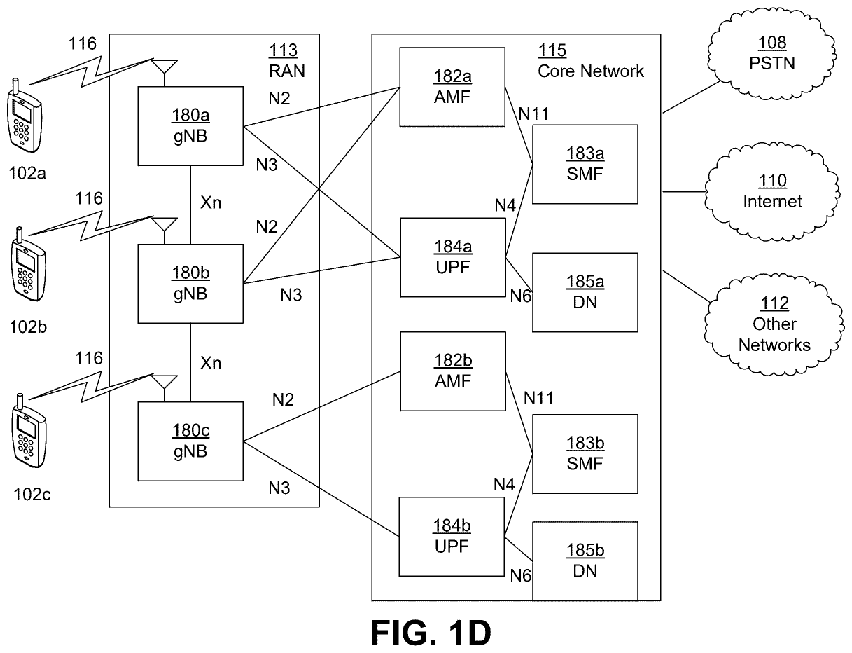

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may receive, for example from a network, configuration information. The configuration information may include a plurality of processing configurations. Each processing configuration of the plurality of processing configurations may include one or more parameters, for example for at least one or more of uplink (UL) processing and/or downlink (DL) processing. The configuration information may include one or more triggering conditions. The WTRU may operate in accordance with a first processing configuration of the plurality of processing configurations.

The WTRU may determine to operate in a second processing configuration of the plurality of processing configurations, for example based on the one or more triggering conditions being met. The one or more triggering conditions may be associated with the second processing configuration of the plurality of processing configurations. Additionally, or alternatively, the one or more triggering condition may be associated with a subset and/or each of the plurality of processing configurations. The WTRU may send an indication of the second processing configuration, for example to the network. The WTRU may operate in accordance with the second processing configuration of the plurality of processing configurations, for example based on a determination that the one or more triggering conditions has been met.

The WTRU may determine that a processing configuration of the plurality of processing configurations is a preferred processing configuration, for example based on the indication of the second processing configuration. Additionally, or alternatively, the WTRU may determine that a processing configuration of the plurality of processing configurations is a preferred processing configuration, based on at least one preferred value associated with at least one of the one or more parameters. The WTRU may send the indication of the second processing configuration to the network in at least one radio control element message. The radio control element message may be associated with at least one control element.

The one or more triggering conditions may include an amount of data in a buffer exceeding a threshold amount. The WTRU may receive an indication from the network to operate in accordance with the second processing configuration. The one or more triggering conditions may include the indication from the network to operate in accordance with the second processing configuration. The second processing configuration may be associated with a service. The WTRU may determine when data associated with the service is received. The triggering condition associated with each of the plurality of processing configurations may include reception of data associated with the service.

The first processing configuration of the plurality of processing configurations may be associated with a first quality of service and/or the second processing configuration of the plurality of processing configurations may be associated with a second quality of service. The one or more triggering conditions may include reception of data associated with the second quality of service.

The WTRU may send a request to the network to operate in accordance with the second processing configuration. The WTRU may receive a response indicating that the WTRU should operate in accordance with the second processing configuration. The WTRU may operate in accordance with a third processing configuration, for example based on the one or more triggering conditions. The WTRU may switch from a first carrier to a second carrier to operate in the third processing configuration.

Systems and methods may enable a WTRU to adapt parameter(s) associated with a WTRU processing configuration, for example bandwidth, PDCCH monitoring, and/or a (e.g., maximum) number of multiple input multiple output (MIMO) layers. Processing parameters may be controlled/signaled by network, for example without considering WTRU input. The network may consider UE assistance information (UAI). A UAI RRC message may enable the WTRU to indicate preferred/maximum WTRU processing parameter(s) (e.g., maximum bandwidth, number of carriers, MIMO layer). A UAI RRC may be semi-static (RRC) and/or there may be no mandate for the network to configure the preferred parameters for the WTRU. WTRU processing configuration herein may be used interchangeably with processing configuration.

The WTRU may not optimize parameter(s) for example. For example processing parameters may be controlled separately within a cell/carrier. Bandwidth, PDCCH monitoring, a maximum number of MIMO layers, a WTRU processing timeline (K0, K2) may be indicated/controlled per cell/carrier. No adaptation of the number of Rx/RF chains may be supported in some systems, for example except the maximum MIMO layer per BWP. The network may not need to schedule the maximum MIMO layer configured per BWP in some example scenarios.

There may be no mechanism to control/adapt all WTRU processing parameters in all carriers/cell. Systems and methods that enable a WTRU to adapt processing quickly and/or optimize processing may be desirable. Scheduler flexibility and/or quality of service (QoS)/quality of experience (QoE) of the WTRU may be balanced, for example with processing/power saving for the WTRU.

A WTRU may determine to use a (e.g., another) WTRU processing configuration, for example based on a triggering condition for using the WTRU processing configuration. For example, the WTRU may determine to use a different WTRU processing configuration when a triggering condition is satisfied (e.g., met). The WTRU may send an indication, for example to the network. The WTRU may send the indication, for example after determining to use the other WTRU processing configuration. The indication may indicate whether the WTRU is ready to use the WTRU processing configuration. For example, the WTRU may send a request to the network to operate in accordance with and/or apply the WTRU processing configuration. The WTRU may receive a response from the network. The response may indicate that the WTRU should operate in accordance with the WTRU processing configuration. The WTRU may send the request based on a triggering condition being met. Additionally, or alternatively, the WTRU may send an indication to the network that the WTRU is ready to use and/or will apply the WTRU processing configuration.

The WTRU may be configured with configuration information, for example received from the network. The configuration information may include a plurality of WTRU processing configurations. A (e.g., each) WTRU processing configuration may include a set of WTRU processing parameters, for example for UL processing, DL processing, and/or UL/DL WTRU processing. The configuration information may additionally or alternatively include an indication of one or more triggering conditions.

For DL WTRU processing/reception for example, a WTRU processing configuration may be associated with the WTRU using 1 reception (Rx)/1 radio frequency (RF) and/or monitoring PDCCH in an anchor cell with a first PDCCH monitoring periodicity (e.g., sparse). Another WTRU processing configuration may be associated with the WTRU using 4Rx/4RF and/or monitoring PDCCH in a plurality of (e.g., all) carriers/cells with a second PDCCH monitoring periodicity.

For UL WTRU processing/transmission for example, a WTRU processing configuration may be associated with the WTRU using transmission (Tx)/RF antennas for UL transmission in anchor cell. Another WTRU processing configuration may be associated with the WTRU using a plurality of (e.g., all) 4Tx/RF for uplink transmission, for example in both anchor and multiple data carriers.

For UL/DL WTRU processing for example, there may be a profile associated with a small number of HARQ process IDs, and/or large values of the minimum gap between DCI and PDSCH/PUSCH (e.g., K0, K2) and/or between CSI-RS and CSI reporting (e.g., Z). Another profile may be associated with large number of HARQ process IDs, and/or small values of the minimum gap between DCI and PDSCH/PUSCH (e.g., K0, K2) and/or between CSI-RS and CSI reporting (e.g., Z).

Triggering condition(s) may apply to a (e.g., each) WTRU processing configuration. For example, a triggering condition may be indicated by the network (e.g., using LP-WUS, DCI, MAC-CE, RRC). A triggering condition may include a configuration between one or more WTRU processing configurations and a service (e.g., the availability of data in a configured set of QoS flows). A (e.g., each) WTRU processing configuration of a service may be associated with a QoS flow to DRB mapping. A (e.g., each) processing configuration of a service may be associated with a QoS flow, for example of a set of QoS flows associated with the service. A triggering condition may include an amount of data in the buffer being greater than a configured threshold.

A WTRU may operate with a first WTRU processing configuration, for example a low power/intensity WTRU processing configuration which may be associated with the WTRU using an Rx to monitor a (e.g., spare) PDCCH. The WTRU may determine to use a second WTRU processing configuration, for example a high power/intensity WTRU processing configuration (e.g., associated with using 4Rx to monitor dense PDCCH). The WTRU may determine to use the second processing configuration, for example when the triggering condition to use the second WTRU processing configuration is satisfied. For example, the triggering condition may include the WTRU receiving an indication from the network to switch to the second WTRU processing configuration, data associated with XR/URLLC service arriving/being received at the WTRU, and/or the amount of data in the buffer being greater than a configured threshold.

The WTRU may send WTRU processing configuration information (UPCI) to the network, for example indicating a preferred WTRU processing configuration and/or whether the WTRU is ready to use a WTRU processing configuration associated with a service (e.g., XR/URLLC). The WTRU may operate in the second WTRU processing configuration (e.g., high power/intensity WTRU processing configuration and/or the WTRU using 4Rx/4RF and/or monitoring PDCCH in all configured carriers/cells with the dense PDCCH monitoring periodicity).

Systems and methods may enable a WTRU to quickly adapt a processing WTRU processing configuration, for example to minimize the WTRU processing and/or minimize the impact on QoS/QoE degradation and/or impact on network scheduling flexibility.

The term network may be used to describe a base station serving the WTRU, a gNB, a 6G gNB, a TRP, a network entity such as LMF, and/or a coordinator device (e.g., a relay WTRU, another WTRU, a group coordinator) for example.

As herein the WTRU being/is configured with something may be used to indicate that the WTRU is preconfigured and/or the WTRU receives a network configuration. The network configuration may be received via a SIB, a dedicated RRC message, MAC CE, and/or DCI for example. For example, the WTRU being configured with a threshold may be equivalent to the WTRU being preconfigured (e.g., the WTRU stores the configuration) with the threshold and/or the WTRU receiving the threshold, from the network (e.g., via SIB, RRC, MAC CE, and/or DCI).

Herein an indication from the network and configuration from the network may be used interchangeably, for example to describe the WTRU receiving the control (e.g., scheduling decision) from the network. The WTRU may receive an indication/configuration from the network via any downlink reception, for example SSB, MIB, SIB, NAS, RRC, MAC-CE, and/or DCI.

A radio control element (RCE) may be used to refer to one or more control elements in any protocol layer, for example PHY (e.g., LP-WUS, UCI, DCI), MAC (e.g., MAC-CE), RLC (e.g., control RLC), PDCP (e.g., Control PDCP), SDAP (e.g., control SDAP), RRC (e.g., an RRC message), and/or a new protocol for new types of data handling such as AIML, sensing, computing (e.g., a control data plane adaptation protocol (DPAP)).

There may be a QoS treatment profile associated with a control/data unit. An application may provide one or more IP flows for transmission over a medium. An (e.g., each) IP flow may (e.g., then) go through a transport layer protocol (e.g. TCP/IP, QUIC, RTP, MOC etc). An (e.g., each) IP flow (e.g. a PDU session) may go through a RAN core network, which for example may map the IP flow to a RAN data flow and/or a RAN data set. For a (e.g., each) RAN data flow for example, the core network may attach one or more QoS requirements, a QoS metric, and/or a range of QoE metrics.

Herein a RAN data flow may represent a logical association between data units, for example originating from the same IP flow. The association may be based on data units being associated with the same IP flow, application flow, and/or having the same association packet marked (e.g., either) by the core network and/or the application.

Some RAN data flows may not originate from a user application and/or may originate from a control plane (e.g. control data and/or RAN signaling and configurations), an intelligence plane (e.g. data collected from AI/ML services), a computing plan (e.g. used for native computing for computing services), a system plane (i.e. data originating within the RAN, e.g. due to sensing or positioning services), and/or a security plane.

The WTRU may assign a QoS class to a (e.g., each) control/data unit within a RAN data flow, for example for characterization of how control/data should be transmitted. A protocol plane may contain a control/data unit classification function for QoS class marking throughout the protocol chain. The QoS class may be determined in such a layer according to one or more configured or predefined rule. The QoS class may be used in various layers within the data plan protocol chain for achieving a certain QoS requirement.

A (e.g., each) QoS class may be associated with a QoS treatment profile in the RAN, which for example may be configured semi-statically and/or changed dynamically. A (e.g., each) QoS treatment profile may contain a number of parameters to control the RAN treatment of the data transmission/reception and/or a number of metrics to achieve the QoS/QoE level for a (e.g., given) layer in the protocol chain. A (e.g., each) QoS class and/or QoS treatment profile may be associated with and/or configured with one or more QoS parameters (e.g., a priority, an importance level, a delay bound, a reliability level, a guaranteed bit rate, a maximum bit rate, and/or a maximum packet loss rate).

A WTRU may transmit and/or receive a physical channel and/or reference signal according to one or more spatial domain filter. The term beam may be used to refer to a spatial domain filter.

The WTRU may transmit a physical channel and/or signal using the same spatial domain filter as the spatial domain filter used for receiving an RS (e.g., CSI-RS) and/or a SS block. The WTRU transmission may be referred to as target and/or the received RS or SS block may be referred to as reference and/or source. For example, the WTRU may be said to transmit the target physical channel and/or signal according to a spatial relation with a reference to such RS and/or SS block.

The WTRU may transmit a first physical channel and/or signal according to the same spatial domain filter as the spatial domain filter used for transmitting a second physical channel and/or signal. The first and second transmissions may be referred to as target and reference or source, respectively. For example the WTRU may be said to transmit the first (e.g., target) physical channel and/or signal according to a spatial relation with a reference to the second (e.g., reference) physical channel or signal.

A spatial relation may be implicit, configured by RRC, and/or signaled by MAC CE and/or DCI. For example, a WTRU may implicitly transmit PUSCH and/or DM-RS of PUSCH according to the same spatial domain filter as an SRS indicated by an SRS resource indicator (SRI) indicated in DCI and/or configured by RRC. A spatial relation may be configured by RRC for an SRI and/or signaled by MAC CE for a PUCCH for example. Such spatial relation may additionally or alternatively be referred to as a beam indication.

The WTRU may receive a first (e.g., target) downlink channel and/or signal according to the same spatial domain filter or spatial reception parameter as a second (e.g., reference) downlink channel and/or signal. For example, an association may exist between a physical channel (e.g., PDCCH and/or PDSCH) and a respective DM-RS. When the first and/or second signals are reference signals for example, the association may exist when the WTRU is configured with a quasi-colocation (QCL) assumption type D between corresponding antenna ports. The association may be configured as a transmission configuration indicator (TCI) state.

A WTRU may be indicated with an association between a CSI-RS and/or SS block and a DM-RS, for example by an index to a set of TCI states configured by RRC and/or signaled by MAC CE. The indication may additionally or alternatively be referred to as a beam indication. Herein RS may be interchangeably used with one or more of RS resource, RS resource set, and/or RS port and RS port group. Herein RS may be interchangeably used with one or more of SSB, CSI-RS, and/or SRS and DM-RS.

Herein a frequency-block may be used to describe/indicate a set of (e.g., contiguous) PRBs, for example used for uplink transmission and/or downlink reception. A frequency-block may include a BWP, a subset of a BWP, a carrier or a subset of a carrier, and/or a resource pool or a subset of a resource pool.

Systems and methods may include configuration of WTRU processing configuration(s). The WTRU may be (pre-)configured with a plurality of WTRU processing configurations. A (e.g., each) WTRU processing configuration may include one or more (e.g., a set of) WTRU processing parameter. The WTRU processing parameter(s) may be associated with uplink (UL) WTRU processing/transmission, downlink (DL) WTRU processing/reception, and/or UL/DL WTRU processing/transmission. A (e.g., each) WTRU processing parameter(s) may be associated with one or more processing layers (e.g., PHY, MAC, RLC, PDCP, SDAP).

For each WTRU processing parameter for example, the WTRU may be configured with a range of values, a set of values, a minimum value, a maximum value, and/or an exact value. Each parameter may be configured to be frequency-block specific (e.g., cell-specific, BWP-specific), group-of-frequency-blocks specific (e.g., group-of-cell-specific, cell-specific, group-of-carriers-specific), and/or WTRU-specific. A (e.g., each) WTRU processing parameter may be configured per direction (e.g., UL or DL) or may be common for both directions (e.g., UL/DL). Herein a parameter described for one direction may be applicable for the other direction.

The WTRU may be (pre-)configured with one or more parameters associated with UL processing/transmission. The WTRU may be (pre-)configured with one or more WTRU processing configurations, for example where a (e.g. each) processing configuration includes one or more sets of one or more uplink WTRU processing/transmission parameters. A (e.g., each) uplink WTRU processing/transmission parameter may be associated with whether an UL transmission is enabled/disabled, The UL transmission may be a data/control transmission (e.g., UL-LP-WUS, UCI, SR, BSR, MAC-CE, PUCCH, and/or PUSCH), and/or a transmission of one or more types of reference-signals such as SRS, SRSp, sensing reference signal.

For example, the WTRU may be configured with two WTRU processing configurations, where one WTRU processing configuration may be associated with uplink transmission enabled, and another WTRU processing configuration WTRU processing configuration may be associated with uplink transmission disabled. For example, the WTRU may be configured with two WTRU processing configurations, where one WTRU processing configuration may enable SRSp transmission, and another WTRU processing configuration may disable SRSp transmission.

A (e.g., each) uplink WTRU processing/transmission parameter may be associated with a configuration associated with a (e.g., certain) type of uplink transmission, for example a data/control transmission, UL-LP-WUS, UCI, SR, BSR, MAC-CE, PUCCH, and/or PUSCH, and/or a transmission of one or more types of reference-signals (e.g., SRS, SRSp, and/or sensing reference signal). For example the WTRU may be configured with a plurality of WTRU processing configurations. A (e.g., each) WTRU processing configuration may be associated with a SRS transmission configuration. A (e.g. each) SRS transmission configuration may include one or more of the periodicity of SRS transmission, the set of SRS resources, the set of beams, and/or the number of SRS ports, etc. For example, the first WTRU processing configuration may be associated with the WTRU transmitting SRS with the first periodicity and/or the second WTRU processing configuration may be associated with the WTRU transmitting SRS with the second periodicity. For example, the first WTRU processing configuration may be associated with the WTRU transmitting in one single port SRS resource and/or the second WTRU processing may be associated with the WTRU transmitting in X (e.g., X=2) single port SRS resources. The WTRU may be enabled to turn off one or more RF chains for SRS transmission.

The WTRU may be configured with a plurality of WTRU processing configurations, for example where a (e.g., each) WTRU processing configuration may be associated with a PUCCH configuration. For example the first PUCCH configuration may enable a PUCCH resource with the first periodicity. The second PUCCH configuration may enable another PUCCH resource with the second periodicity. The second PUCCH resource may be a subset of the first PUCCH resource.

The WTRU may be configured with two WTRU processing configurations, for example where the first WTRU processing configuration may enable the WTRU to transmit UL-LP-WUS and/or the second WTRU processing configuration may not enable the WTRU to transmit UL-LP-WUS. For example, the WTRU may be configured with two other WTRU processing configurations. The first WTRU processing configuration may configure the WTRU with the first periodicity of UL-LP-WUS and/or the second WTRU processing configuration may configure the WTRU with the second periodicity of UL-LP-WUS.

The WTRU may be configured with one or more UL configured grant (e.g., type 1 configured grant). The WTRU may be configured with two WTRU processing configurations, for example where the first WTRU processing configuration may enable the WTRU to transmit in the configured grant. The second WTRU processing configuration may disable the WTRU to transmit in the configured grant.

A (e.g., each) uplink WTRU processing/transmission parameter may be associated with an uplink data rate. For example, the WTRU may be configured with one WTRU processing configuration (e.g., the low data rate capability) enabling the WTRU to transmit up to the first (pre-)configured maximum data rate. The WTRU may be configured with another WTRU processing configuration (e.g., the high data rate capability) enabling the WTRU to transmit with a high data rate.

A (e.g., each) uplink WTRU processing/transmission parameter may be associated with one or more parameters associated with the WTRU processing/transmission bandwidth, which for example may include one or more parameters. The one or more parameters may include a set of active frequency-blocks (e.g., carrier, BWP) for uplink transmission and/or a (e.g., maximum) transmission bandwidth. The set of active frequency-blocks (e.g., carrier, BWP) for uplink transmission may include the set of active frequency-blocks (e.g., BWP, component carriers) for control/data transmission and/or one or more types of reference-signal transmissions (e.g., SRS, SRSp, reference-signal for sensing).

For example, the WTRU may be configured with two WTRU processing configurations, in which each WTRU processing configuration may be associated with one set of active carriers. The first WTRU processing configuration may enable the WTRU to transmit in one carrier (e.g., anchor carrier with small bandwidth). The second WTRU processing configuration may enable the WTRU to transmit in two carriers (e.g., anchor carrier and data carrier). The maximum transmission bandwidth may include the maximum transmission bandwidth per frequency-block (e.g., per carrier), and/or per set of frequency-blocks (e.g., per frequency-band, per band combination).

For example, the WTRU may be configured with two WTRU processing configurations, in which each WTRU processing configuration may be associated with a maximum transmission bandwidth of the WTRU. The first WTRU processing configuration may enable the WTRU to transmit up to a first configured maximum bandwidth (e.g., small bandwidth of 5 MHz) and/or the second WTRU processing configuration may enable the WTRU to transmit up to a second configured maximum bandwidth (e.g., large bandwidth of up to 400 MHz).

A (e.g., each) uplink WTRU processing/transmission parameter may be associated with one or more parameters associated with RF operation, for example which may include one or more parameters. The one or more parameters may include a number of antennas and/or a set of antennas, a number of RF chains and/or a set of RF chains, and/or a number of MIMO layers.

The one or more parameters may include a number of antennas and/or the set of antennas. For example, the WTRU may be equipped with 4Tx antennas. The WTRU may be configured with two WTRU processing capabilities, for example where the first WTRU processing configuration (e.g., low WTRU processing configuration) may enable the WTRU to use one Tx antenna and/or the second WTRU processing configuration may enable the WTRU to use all 4Tx antennas.

The one or more parameters may include a number of RF chains and/or the set of RF chains. For example the WTRU may be equipped with two RF chains. The WTRU may be configured with two WTRU processing capabilities, for example where the first WTRU processing configuration (e.g., low WTRU processing configuration) may enable the WTRU to use one RF chain and/or the second WTRU processing configuration may enable the WTRU to use all two RF chains. The first WTRU processing configuration may enable the WTRU to turn off one RF chain to save WTRU processing, and/or the second WTRU processing configuration may be associated with the WTRU keeping both RF chains active.

The WTRU may be equipped with two set of RF chains, for example where one set of RF chains may be associated with FR1 and/or another set of RF chains may be associated with FR2. The WTRU may (e.g., then) be configured with one WTRU processing configuration, for example enabling the first set of RF chains, which may enable the WTRU to transmit in FR1. The WTRU may be configured with another WTRU processing configuration, for example enabling the second set of RF chains. This WTRU processing configuration may enable the WTRU to transmit data in FR2, for example with a high data rate. The WTRU may additionally or alternatively be configured with another WTRU processing configuration, for example enabling both the first and the second set of RF chains. This WTRU processing configuration may enable the WTRU to transmit in both FR1 and FR2.

The one or more parameters may include a number of MIMO layers. For example, the WTRU may be equipped with 4Tx, which may be able to support up to 4 MIMO layers for uplink transmission. The WTRU may be configured with three possible WTRU processing configurations, for example where a (e.g., each) WTRU processing configuration may be associated with a maximum number of MIMO layer transmission. The WTRU may be configured with a low WTRU processing configuration, for example with (e.g., only) one MIMO layer transmission. The WTRU may be configured with a high WTRU processing configuration, for example with a maximum of 4 MIMO layer transmission.

A (e.g., each) uplink WTRU processing/transmission parameter may be associated with one or more parameters associated with TB transmission, which for example may include one or more parameters. The one or more parameters may include an MCS, a TB size, and/or a transmission power.

The one or more parameters may include the MCS. The WTRU may be configured with two WTRU processing configurations, for example where a (e.g., each) processing WTRU processing configuration may be associated with a maximum modulation order for transmission. For example, the first WTRU processing configuration may be associated with maximum MCS of 64 QAM and/or the second WTRU processing configuration may be associated with the maximum MCS of 256 QAM.

The one or more parameters may include the transport block (TB) size. The WTRU may be configured with a plurality of WTRU processing configurations, for example where a (e.g., each) processing WTRU processing configuration may be associated with a maximum TB size. The WTRU may be configured with two WTRU processing configurations, for example where one WTRU processing configuration (e.g., low WTRU processing capability) may be associated with the first maximum TB size (e.g., a small TB size), and/or another WTRU processing configuration (e.g., high WTRU processing configuration) may be associated with the second maximum TB size (e.g., a large TB size).

The one or more parameters may include the transmission power. The WTRU may be configured with a plurality of WTRU processing configurations, for example where a (e.g., each) processing WTRU processing configuration may be associated with a maximum transmission power.

The WTRU may be configured with a plurality of WTRU processing configurations. A (e.g., each) WTRU processing configuration may contain one or more sets of uplink WTRU processing/transmissions (e.g., related to transmission bandwidth) and/or the configuration of a certain type of uplink transmission. The first WTRU processing configuration may enable the WTRU not to perform any uplink transmission. The second WTRU processing configuration may enable the WTRU to transmit SRS in one carrier (e.g., anchor carrier). The third WTRU processing configuration may enable the WTRU to transmit both SRS, and control/data (e.g., PUSCH/PUCCH) in one carrier (e.g., anchor carrier). Another WTRU processing configuration may enable the WTRU to transmit SRS and control/data in a plurality of carriers (e.g., anchor carrier and data carrier).

The WTRU may be configured with a plurality of WTRU processing configurations, for example (e.g., each) containing sets of uplink WTRU processing/transmission related to bandwidth, RF operation, and/or TB transmission. The first WTRU processing configuration may enable the WTRU to use one RF chain, for example to transmit with one MIMO layer in one carrier (e.g., anchor carrier) (e.g., using maximum 64 QAM modulation). The second WTRU processing configuration may enable the WTRU to use two RF chains, for example to transmit with a maximum of two MIMO layers in one carrier (e.g., using maximum 64 QAM modulation). Another WTRU processing configuration may enable the WTRU to use 4 RF chains to transmit with maximum four MIMO layer in multiple carriers using maximum 256 QAM modulation.

A WTRU may be configured to one or more parameters associated with downlink processing/reception. The WTRU may be (pre-)configured with one or more WTRU processing configurations, for example (e.g., each) containing one or more sets of one or more downlink WTRU processing/reception parameters. A (e.g., each) downlink WTRU processing/reception parameter may be associated with one or more parameters, configuration, computation, and/or rate.

A (e.g., each) downlink WTRU processing/reception parameter may be associated with one or more parameters associated with the WTRU processing/reception bandwidth, which for example may include one or more parameters. The one or more parameters may include a set of active frequency-blocks and/or a maximum reception bandwidth.

The one or more parameters may include a set of active frequency-blocks (e.g., carrier, BWP) for downlink reception, which for example may include the set of active frequency-blocks for downlink control/data reception, and/or one or more types of downlink reference-signal (e.g., SSB, CSI-RS, DL-PRS, reference-signal for sensing) reception/measurement/reporting for one or more types of reference-signals. The set of active frequency blocks may include an indication of whether each frequency-block, each group of frequency-block, and/or all frequency-blocks may be active/inactive.

The WTRU may be configured with a WTRU processing configuration (e.g., a minimum reference-signal monitoring configuration), which for example may be associated with the WTRU to performing a CSI-RS measurement and/or reporting in one frequency-block (e.g., anchor carrier). The WTRU may be configured with one WTRU processing configuration (e.g., a minimum data rate configuration), for example which may be associated with the WTRU monitoring/receiving control/data (e.g., monitor PDCCH for inter-frequency-block scheduling) in one frequency-block (e.g., in anchor carrier). The WTRU may determine that when control/data reception in a frequency-block is enabled, the WTRU may perform CSI-RS measurement and/or reporting in the frequency-block.

The WTRU may be configured with another WTRU processing configuration (e.g., a medium data rate WTRU processing configuration), for example which may be associated with the WTRU monitoring/receiving control/data in both one or more anchor carrier and one or more data carriers associated with one cell (e.g., Pcell). The WTRU may be configured with another WTRU processing (e.g., a high data rate WTRU processing configuration), which for example may be associated with the WTRU monitoring/receiving control/data in an anchor carrier and/or a plurality of data carrier from a plurality of cells in both FR1 and FR2.

The one or more parameters may include a maximum reception bandwidth, which for example may include the maximum reception bandwidth per frequency-block (e.g., per carrier), per set of frequency-blocks (e.g., per frequency-band, per band combination), and/or reception bandwidth for the WTRU (e.g., WTRU-specific reception bandwidth). The WTRU may be configured with two WTRU processing/reception configurations, for example where a (e.g., each) WTRU processing configuration may be associated with a maximum reception bandwidth of the WTRU. The first WTRU processing configuration may enable the WTRU to receive up to a first configured maximum bandwidth (e.g., small bandwidth of 5 MHz) and/or the second WTRU processing configuration may enable the WTRU to receive up to a second configured maximum bandwidth (e.g., large bandwidth of up to 400 MHz).

The WTRU may be configured with a plurality of WTRU processing/reception configurations. One WTRU processing/reception configuration may not allow the WTRU to perform carrier aggregation. Another WTRU processing/reception configuration may allow the WTRU to perform contiguous carrier aggregation, for example of up to two carriers to maximum of 40 MHz. Another WTRU processing/reception configuration may enable the WTRU to perform intra-band non-contiguous carrier aggregation. Another WTRU processing/reception configuration may enable the WTRU to perform inter-band carrier aggregation.

A (e.g., each) downlink WTRU processing/reception parameter may be associated with one or more parameters associated with PDCCH monitoring. The one or more parameters associated with PDCCH monitoring may include an indication of whether PDCCH monitoring is enabled/disabled, a set of active frequency-clocks, a CORESET(s) to monitor, which SSSGs to monitor, and/or a number of BDs/CCEs and/or the set of BDs/CCEs to monitor PDCCH containing DCI per slot.

The one or more parameters associated with PDCCH monitoring may include an indication of whether monitoring PDCCH is enabled/disabled, which may include whether PDCCH monitoring is enabled/disabled for each frequency-block (e.g., BWP, carrier, a CORESET, a search space set, a search space set group), a group of frequency-blocks, and all frequency-blocks. The WTRU may be configured with two WTRU processing configurations, for example where one WTRU processing configuration may disable the WTRU to monitor PDCCH, and/or another WTRU processing configuration may enable the WTRU to monitor PDCCH. When the WTRU is configured to monitor PDCCH for example, the WTRU may be configured with a plurality of processing configurations. For example, a (e.g., each) WTRU processing configuration may be associated with a different level of PDCCH monitoring activity.

The one or more parameters associated with PDCCH monitoring may include an indication of the set of active frequency-blocks (e.g., carrier, BWP, CORESET, a search space set, and/or a search space set group) for PDCCH monitoring. For example when the WTRU is configured to monitor PDCCH, the WTRU may be configured with two WTRU processing configuration associated with the set of active frequency-blocks for PDCCH monitoring. A first WTRU processing configuration may enable the WTRU to monitor PDDCH in anchor carrier and/or another WTRU processing configuration may enable the WTRU to monitor PDCCH in a plurality of (e.g., all) configured carriers.

The one or more parameters associated with PDCCH monitoring may include an indication of which CORESET(s) to monitor. The WTRU may be configured with two CORESETs in a BWP. The WTRU may monitor the first CORESET (e.g., small CORESET with small number of CCEs), for example if the WTRU is operating in one WTRU processing configuration (e.g., low-capability WTRU processing). If the WTRU operates in another WTRU processing configuration (e.g., high-capability WTRU processing) for example, the WTRU may monitor the second CORESET (e.g., large CORESET with large number of CCEs).

The WTRU may be configured with two CORESETs, for example where each CORESET may be associated with one BWP/carrier. The WTRU may monitor DCI in the first CORESET, which may be associated with the first BWP/carrier, for example if the WTRU is operating in the first WTRU processing configuration. The WTRU may monitor DCI in the second CORESET, which may be associated with the second BWP/carrier, for example if the WTRU is operating in the second WTRU processing configuration.

The one or more parameters associated with PDCCH monitoring may include an indication of which search-space-set groups (SSSGs) to monitor. The WTRU may be configured with two WTRU processing configurations. The WTRU may monitor the first search-space-set (e.g., a search-space-set with sparse PDCCH monitoring periodicity), for example if the WTRU is operating in the first WTRU processing configuration (e.g., low data-rate processing assumption). The WTRU may monitor the second search-space-set (e.g., a search-space-set with dense PDCCH monitoring periodicity), for example if the WTRU is operating the second WTRU processing configuration (e.g., high data-rate processing assumption).

The WTRU may be configured with two search-space-set groups in one BWP, for example where a (e.g., each) search-space-set group may be associated with one WTRU processing configuration. For the first WTRU processing configuration for example, the WTRU may monitor the first search-space-set containing intra-carrier scheduling DCI. For the second WTRU processing configuration for example, the WTRU may monitor the second search-space-set group containing intra-carrier, inter-carrier and/or multi-carrier scheduling DCIs.

The WTRU may be configured with two search-space-set groups, for example where a (e.g., each) search-space-set group may be associated with a WTRU processing configuration. The first search-space-set group may be associated with a CORESET in one carrier (e.g., high-data rate carrier) and/or the second search-space-set group may be associated with a CORESET in another carrier (e.g., low data rate carrier such as anchor carrier, perch carrier).

The one or more parameters associated with PDCCH monitoring may include an indication of a number of BDs/CCEs and/or the set of BDs/CCEs to monitor PDCCH containing DCI per slot. The WTRU may be configured with two WTRU processing configurations associated with the PDCCH detection. The first WTRU processing configuration may be associated with the WTRU detecting PDCCH using a first maximum/minimum number of BDs/CCEs per slot (e.g., Low WTRU processing configuration). The second WTRU processing configuration may be associated with the WTRU detecting PDCCH using a second maximum/minimum number of BDs/CCEs (e.g., high WTRU processing configuration).

A (e.g., each) downlink WTRU processing/reception parameter may be associated with one or more parameters associated with RF operation. The one or more parameters may include a number of antennas and/or the set of antennas, a number of RF chains and/or the set of RF chains, and/or a number of MIMO layers.

The one or more parameters may include the number of antennas and/or the set of antennas. The WTRU may be equipped with 4Rx antennas. The WTRU may be configured with two WTRU processing capabilities, for example where the first WTRU processing configuration (e.g., low WTRU processing configuration) may enable the WTRU to use one Rx antenna for reception and/or the second WTRU processing configuration may enable the WTRU to use a plurality of (e.g., all) 4Rx antennas for reception. The low WTRU processing configuration may enable the WTRU to disable 3 Rx antennas, which for example may help the WTRU to save its processing.

The one or more parameters may include the number of RF chains and/or the set of RF chains. The WTRU may be equipped with two RF chains. The WTRU may be configured with two WTRU processing capabilities, for example where the first WTRU processing configuration (e.g., low WTRU processing configuration) may enable the WTRU to use one RF chain and/or the second WTRU processing configuration may enable the WTRU to use a plurality of (e.g., two) RF chains.

The one or more parameters may include the number of MIMO layers. For example, the maximum number of MIMO layers may be configured per frequency-block (e.g., per BWP, per carrier). The maximum number of MIMO layers may be configured per set of frequency-blocks (e.g., per FR, per set of carriers, per carriers, per cell) for example. The maximum number of MIMO layers may be configured to be WTRU-specific, for example where the maximum MIMO layer may be applicable for all transmission of the WTRU in all frequency-blocks.

The WTRU may be equipped with 8Rx, which for example may be able to support up to 8 MIMO layers reception. The WTRU may be configured with three possible WTRU processing configurations, for example where a (e.g., each) WTRU processing configuration may be associated with a maximum number of MIMO layer reception. The WTRU may be configured with a low WTRU processing configuration, for example with (e.g., only) one MIMO layer reception. The WTRU may be configured with a medium WTRU processing configuration, for example with maximum of 4 MIMO layer reception. The WTRU may be configured with a high WTRU processing configuration, for example with maximum of 8 MIMO layer reception.

A (e.g., each) downlink WTRU processing/reception parameter may be associated with one or more parameters associated with TB reception, which for example may include one or more parameters. The one or more parameters may include an MCS and/or a TB size.

The one or more parameters may include the MCS. The WTRU may be configured with two WTRU processing configurations, for example where a (e.g., each) processing WTRU processing configuration may be associated with a maximum modulation order for transmission. For example the first WTRU processing configuration may be associated with maximum MCS of 64 QAM and/or the second WTRU processing configuration may be associated with the maximum MCS of 1024 QAM.

The one or more parameters may include the TB size. The WTRU may be configured with two WTRU processing configurations associated with TB size for downlink reception, for example where one WTRU processing configuration (e.g., low WTRU processing capability) may be associated with the first maximum TB size (e.g., a small TB size), and/or another WTRU processing configuration (e.g., high WTRU processing configuration) may be associated with the second maximum TB size (e.g., a large TB size).

A (e.g., each) downlink WTRU processing/reception parameter may be associated with one or more parameters associated with downlink data reception. Downlink data reception may be used interchangeably with PDSCH reception. The parameters associated with downlink data reception may include one or more of an indication of whether downlink data reception is enabled/disabled, a downlink data rate, and/or a configuration of downlink data reception.

The parameters associated with downlink data reception may include an indication of whether downlink data reception is enabled/disabled. The WTRU may be configured with a WTRU processing configuration which may disable downlink data reception and/or another WTRU processing configuration which may enable downlink data reception. The WTRU may be configured with two WTRU processing configurations in a carrier, for example where one WTRU processing configuration may enable the WTRU to receive data (e.g., PDSCH) and/or another WTRU processing configuration may disable the WTRU to receive data (e.g., PDSCH).

The parameters associated with downlink data reception may include an indication of a downlink data rate. The WTRU may be configured with one WTRU processing configuration (e.g., the low data rate capability), for example enabling the WTRU to receive up to the first (pre-)configured maximum data rate. The WTRU may be configured with another WTRU processing configuration (e.g., the high data rate capability), for example enabling the WTRU to receive with a high data rate.

The parameters associated with downlink data reception may include an indication of a configuration of downlink data reception. The WTRU may be configured with one or more DL configured grants (e.g., type 1 configured grant). The WTRU may be configured with two WTRU processing configurations. The first WTRU processing configuration may enable the WTRU to receive in the configured grant(s). The second WTRU processing configuration may disable the WTRU to receive in the configured grant(s).

A (e.g., each) downlink WTRU processing/reception parameter may be associated with one or more types of reference-signal reception/measurement/reporting (e.g., SSB, CSI-RS, DL-PRS, reference-signal for sensing). The one or more configurations associated with one or more types of reference-signal reception/measurement/reporting may include an indication of one or more of whether one or more types of reference-signals reception/measurement/reporting is enabled/disabled and/or which configuration associated with one or more types of reference-signals reception/measurement/reporting to use.

The one or more configurations associated with one or more types of reference-signal reception/measurement/reporting may include an indication of whether one or more types of reference-signals (e.g., SSB, CSI-RS, DL-PRS, and/or reference-signal for sensing) reception/measurement/reporting is enabled/disabled. The WTRU may be configured with a WTRU processing configuration, for example which may not enable (e.g., require) the WTRU to perform any downlink reception and/or downlink measurement (e.g., similar to a WTRU in idle/inactive mode). The WTRU may be configured with another WTRU processing configuration, for example which may be associated with the WTRU to measuring/reporting one or more types of reference-signals (e.g., CSI-RS). The WTRU may be configured with two WTRU processing configurations. One WTRU processing configuration may be associated with the WTRU to measuring DL-PRS for positioning and/or another WTRU processing configuration may be associated with the WTRU not to measuring DL-PRS.

The one or more configurations associated with one or more types of reference-signal reception/measurement/reporting may include an indication of an association with one or more types of reference-signals (e.g., CSI-RS, DL-PRS, reference-signal for sensing) reception/measurement/reporting to use. For CSI reception/measurement/reporting for example, the WTRU may be configured with a plurality of CSI measurement reporting. For example each CSI measurement reporting may include one or more parameters. The one or more parameters may include one or more of the periodicity of CSI reporting, the number and/or set of potential scheduling TRPs, the number and/or the set of TRPs for CSI-RS monitoring and/or reporting, the minimum/maximum CSI processing time Z, the set of reporting parameters (e.g., PMI, RI, LI, CQI, and/or RSRP) and/or the resolution associated with each reporting parameter, a CSI-RS hypothesis (e.g., single vs. a plurality of TRPs), a number of reported TRPs, a sub-band-size associated with CSI reporting (e.g., wideband vs. sub-band reporting with different sizes), a number of CWs, max/min rank, CB type (e.g., CB type 1 vs. CB type 2), which codebook profile is enabled/disabled (e.g., CB for high-speed profile vs. low-speed profile), and/or the set of CSI reporting resources.

The WTRU may be configured with a WTRU processing configuration, for example with sparse CSI reporting. The WTRU may be configured with another WTRU processing configuration, for example with dense CSI reporting. The WTRU may be configured with a plurality of WTRU processing configurations associated with the set of CSI reporting parameters, for example where a (e.g., each) WTRU processing configuration may be associated with a set of CSI reporting parameters. The first WTRU processing configuration may be associated with the WTRU reporting maximum one TRP, and/or another WTRU processing configuration may be associated with the WTRU reporting maximum two TRPs.

The WTRU may be configured with a plurality of WTRU processing configurations, for example where a (e.g., each) WTRU processing configuration may be associated with a quantization of one or more parameters for CSI reporting. For example, the WTRU may be configured with a plurality of WTRU processing configurations in which a (e.g., each) WTRU processing configuration may be associated with a size of sub-band reporting for CSI reporting. For example, the WTRU may be configured with a plurality of WTRU processing configurations where a (e.g., each) WTRU processing configuration may be associated with a maximum number of MIMO layers. The WTRU may be configured with a plurality of WTRU processing configurations, for example where a (e.g., each) WTRU processing configuration may be associated with a minimum/maximum CSI processing time.

For DL-PRS reception/measurement/reporting for example, the WTRU may be configured with a plurality of WTRU processing configurations. A (e.g., each) WTRU processing configuration may be associated with one configuration of DL-PRS reception/measurement/reporting. The first configuration of DL-PRS reception/measurement/reporting may enable the WTRU to measure a first bandwidth of DL-PRS and/or the second configuration of DL-PRS reception/measurement/reporting may enable the WTRU to measure a second bandwidth of DL-PRS. The second bandwidth of DL-PRS may be smaller than the first DL-PRS. The first configuration of DL-PRS reception/measurement/reporting may enable the WTRU to report DL-PRS with the first periodicity and/or the second configuration of DL-PRS reception/measurement/reporting may enable the WTRU to report DL-PRS with the second periodicity. The first configuration of DL-PRS reception/measurement/reporting may enable the WTRU to measure the first set of measurement parameters (e.g., RSRP) and/or the second the first configuration of DL-PRS reception/measurement/reporting may enable the WTRU to measure the second set of measurement parameters (e.g., RSRP, RSRPP, and/or LOS/NLOS).

A (e.g., each) downlink WTRU processing/reception parameter may be associated with one or more reference-signal measurement computations (e.g., CSI computing/processing, DL-PRS computing/processing, and/or sensing reference signal computing/processing). The WTRU may be configured with two WTRU processing configurations, for example where the first WTRU processing configuration enables the WTRU to compute the CSI-RS measurement up to a first maximum computation capability (e.g., low WTRU processing configuration) and/or the second WTRU processing configuration enables the WTRU to compute the measurements up to a second maximum computation capability (e.g., high WTRU processing configuration).

A (e.g., each) downlink WTRU processing/reception parameter may be associated with one or more downlink data rates. The WTRU may be configured with two WTRU processing configurations associated with the maximum downlink data rate, for example where one WTRU processing configuration may be associated with the first maximum downlink data rate (e.g., low downlink data rate) and/or another WTRU processing configuration may be associated with the second maximum downlink data rate (e.g., high downlink data rate).

A (e.g., each) downlink WTRU processing/reception parameter may be associated with one or more parameters associated with beam-reporting (e.g., WTRU-initiated/event-driven beam reporting). The WTRU may be configured with a plurality of WTRU processing configurations, for example where a (e.g., each) WTRU processing configuration may be associated with a configuration of beam-reporting. A (e.g., each) beam-reporting configuration may include one or more of the set of events to trigger beam-reporting, the set of monitor beams, the set of resources for beam reporting, and/or the quantity of beam reporting (e.g., the number of reported beams, and/or the metric of beam reporting such as RSRP, RSRQ, and/or SINR).

The WTRU may be configured with a plurality of WTRU processing configurations, for example where a (e.g., each) WTRU processing configuration may be associated with a set of beam-reporting events. The first beam-reporting configuration may include an event E2, for example where the quality of at least one new beam (e.g., L1-RSRP) becomes a threshold value greater than the current beam. The second beam-reporting configuration may include both events E2 and E1. Event E1 may may be triggered, for example if the quality of the current beam is below than a certain threshold.

The WTRU may be configured with a plurality of WTRU processing configurations, for example where a (e.g., each) WTRU processing configuration may be associated with a set of beams for (e.g., potential) beam reporting. The first beam reporting configuration may include one or more beams in the same carrier with the current beam. The second beam reporting configuration may include the beams in a plurality of carriers. For example another beam reporting configuration may include the beams from a plurality of TRPs.

A (e.g., each) downlink WTRU processing/reception parameter may enable one or more configurations of RRM/RLM/BFD/LTM measurement/reporting. The WTRU may be configured with a plurality of WTRU processing configurations, for example where a (e.g., each) WTRU processing configuration may enable a configuration of RRM/RLM/BFD/LTM measurement/reporting. The WTRU may be configured with a plurality of WTRU processing configurations associated with RRM measurement/reporting. The first WTRU processing configuration may be associated with the first set of SSBs/carriers/cells and/or the second WTRU processing configuration may be associated with the second set of SSBs/carriers/cells.

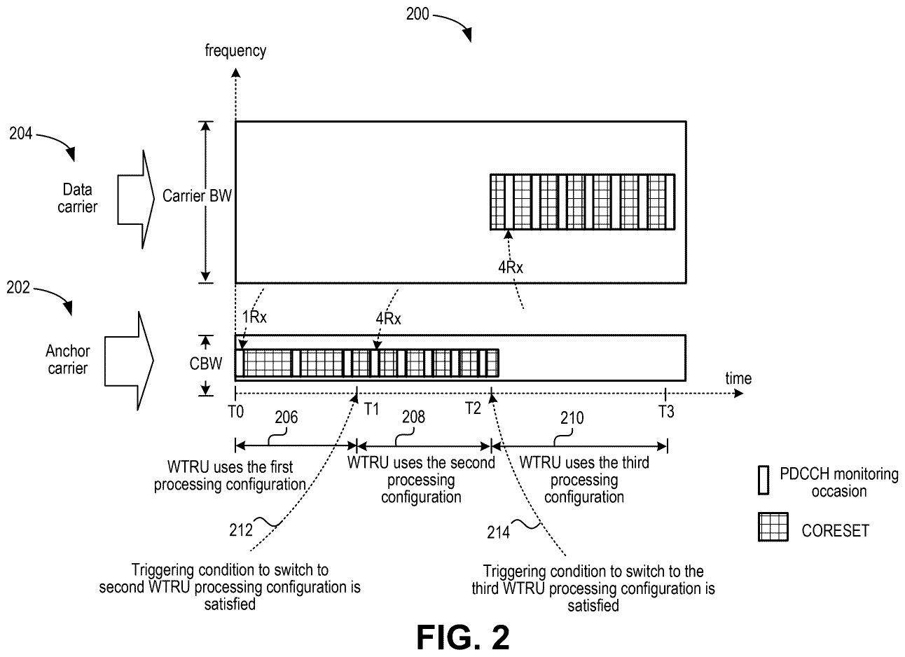

FIG. 2 is an example 200 of a WTRU switch of a configuration based on a triggering condition. The WTRU may be configured with a plurality of WTRU processing configuration associated with RLM measurement/reporting, for example where a (e.g., each) WTRU processing configuration may enable a set of time to evaluate Qin and/or Qout. The WTRU may be configured with a plurality of WTRU processing configuration associated with a BFD, for example where a (e.g., each) WTRU processing configuration may be associated with one periodicity of BFD-RS.

For example as in FIG. 2, the WTRU may be configured with a plurality of WTRU configurations for downlink processing/reception. The WTRU may be configured with a cell including two carriers. The two carrier may include an anchor carrier 202 and a data carrier 204. From time T0 to T1 at 206, the WTRU may use the first WTRU processing configuration, for example where the WTRU may use 1 Rx antenna to monitor PDCCH in the anchor carrier with a sparse PDCCH monitoring periodicity. From T1 to T2 at 208, the WTRU may use the second WTRU processing configuration, for example where the WTRU may use 4Rx antennas to monitor PDCCH in the same anchor carrier with a dense PDCCH monitoring periodicity. From T2 to T3 at 210 a the third WTRU processing configuration may be used, for example where the WTRU may use 4Rx antennas to monitor PDCDH with a dense monitoring periodicity in the data carrier. The WTRU may switch to the second WTRU processing configuration (e.g., at T1) based on a triggering condition 212 to switch to the second WTRU processing configuration being satisfied. The WTRU may switch to the third WTRU processing configuration (e.g., at T2) based on a triggering condition 214 to switch to the third WTRU processing configuration being satisfied. The WTRU may switch to a different carrier, for example the data carrier 204, when switching to a WTRU processing configuration (e.g., the third WTRU processing configuration)

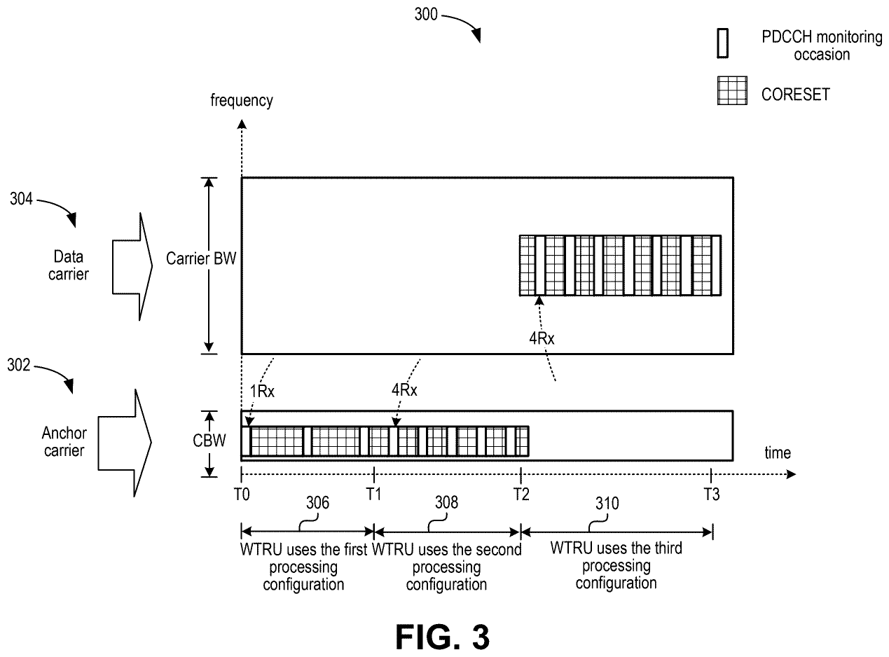

FIG. 3 is an example 300 of a WTRU adapting a configuration across a plurality of carriers. The WTRU may be configured with one or more parameters associated with UL/DL WTRU processing. The WTRU may be (pre-)configured with one or more WTRU processing configurations. A (e.g., each) WTRU processing configuration may include one or more sets of one or more UL/DL WTRU processing parameters. A (e.g., each) UL/DL WTRU processing parameter may be associated with one or more of a maximum CPU processing assumption, a set of HARQ processes for UL transmission and/or DL reception, one or more parameters associated with preparing/processing time for control/data/reference-signal, whether a configured function/feature is enabled/disabled, and/or a configuration associated with one or more functions/features.

The WTRU may be configured with a cell including two carriers, for example an anchor carrier 302 and a data carrier 304. From time T0 to T1 at 306, the WTRU may use the first WTRU processing configuration, for example where the WTRU may use 1 Rx antenna to monitor PDCCH in the anchor carrier with a sparse PDCCH monitoring periodicity. From T1 to T2 at 308, the WTRU may use the second WTRU processing configuration, for example where the WTRU may use 4Rx antennas to monitor PDCCH in the same anchor carrier with a dense PDCCH monitoring periodicity. From T2 to T3 at 310 a the third WTRU processing configuration may be used, for example where the WTRU may use 4Rx antennas to monitor PDCDH with a dense monitoring periodicity in the data carrier. The WTRU may switch to a different carrier, for example a data carrier, when switching to a WTRU processing configuration (e.g., the third WTRU processing configuration).

A (e.g., each) UL/DL WTRU processing parameter may be associated with the maximum CPU processing assumption (e.g. high CPU processing, medium CPU processing, and/or low CPU processing). The WTRU may be configured with two WTRU processing configurations, for example where a (e.g., each) WTRU processing configuration may be associated with one maximum CPU processing assumption. A WTRU processing configuration may be associated with a low CPU processing assumption, and/or another WTRU processing configuration may be associated with high CPU processing assumption. For WTRU implementation for example, the WTRU may be equipped with a plurality of CPU cores, and/or a plurality of RPUs. If the WTRU is configured with a low CPU processing assumption for example, the WTRU may use a small number of CPU cores and/or a small number of RPUs (e.g., the WTRU may use one E-core and/or one RPU). If the WTRU is configured with a high WTRU processing assumption for example, the WTRU may use many CPU cores and/or large number of RPUs (e.g., the WTRU may use all CPU core and/or all RPUs).

A (e.g., each) UL/DL WTRU processing parameter may be associated with the set of HARQ processes for UL transmission and/or DL reception. The WTRU may be configured with two WTRU processing configurations, for example where the first WTRU processing configuration may enable the WTRU to enable all HARQ processes (e.g., 32 HARQ processes) and/or the second WTRU processing configuration may enable the WTRU to enable the first 8 HARQ processes.

A (e.g., each) UL/DL WTRU processing parameter may be associated with one or more parameters associated with preparing/processing time for control/data/reference-signal, for example the minimum PDSCH processing time (N1), the minimum PUSCH preparation time (N2), the CSI-RS processing time (Z), the minimum gap between PDCCH and the associated scheduled PDSCH (K0), the minimum gap between PDSCH and the associated HARQ feedback (K1), and/or the minimum time between PDCCH and the associated PUSCH(K2).

The WTRU may be configured with two WTRU processing configurations, for example where a (e.g., each) WTRU processing configuration may be associated with a set of minimum/maximum values for N1, N2, Z, K0, K1, and/or K2. The WTRU may be configured with a low WTRU processing configuration with large values of N1, N2, Z, K0, K1, and/or K2. The WTRU may be configured with another high WTRU processing configuration with small values of N1, N2, Z, K0, K1, and/or K2. For scheduling for example, a (e.g., each) WTRU processing configuration may be associated with one time domain resource allocation (TDRA) table. The WTRU may (e.g., then) select which TDRA table to use, for example based on the processing WTRU processing configuration the WTRU is operating on. The low WTRU processing configuration may enable the WTRU to transmit/receive a service with delay-tolerant QoS and/or low data rate requirements. The high WTRU processing configuration may enable the WTRU to transmit/receive with high data rate and/or delay-sensitive QoS requirements.

A (e.g., each) UL/DL WTRU processing parameter may be associated with whether a configured function/feature is enabled/disabled. The configured function/feature may include one or more higher layer functions/features, for example UPIP, transmission/reception of certain type of control/data/reference-signal, processing/measuring/reporting of certain reference-signal, data collection for AIML, and/or AIML inference/reporting. The WTRU may be configured with two WTRU processing configurations, for example where one WTRU processing configuration may enable the WTRU to transmit/collect/process AIML/sensing data and/or another WTRU processing configuration may disable the WTRU to transmit/collect/process AIML/sensing data.

A (e.g., each) UL/DL WTRU processing parameter may be associated with the configuration associated with one or more functions/features. The one or more functions/features may include one or more higher layer functions/features, for example QoS flow to QoS treatment profile mapping, UPIP, minimum/maximum supported latency budget, maximum/minimum PBR, maximum/minimum MDBV, minimum/maximum PER, transmission/reception of a certain type of control/data/reference-signal, processing/measuring/reporting of certain reference-signal, data collection for AIML, and/or AIML inference/reporting.

The WTRU may be configured with a plurality of WTRU processing configurations, for example where a (e.g., each) WTRU processing configuration may be associated with one set of user plane configurations (e.g., mapping of QoS flows to QoS treatment profile, a configured multiplexing procedure). The WTRU may be configured with two WTRU processing configurations, for example where the first WTRU processing configuration may have (e.g., only) one QoS treatment profile for (e.g., all) QoS flows and/or the second WTRU processing configuration may include a plurality of QoS treatment profiles for a plurality of QoS flows.

The WTRU may be configured with a plurality of WTRU processing configurations, for example where a (e.g., each) WTRU processing configuration may be associated with a minimum supported latency budget. The WTRU may be configured with a plurality of WTRU processing configurations, for example where a (e.g., each) WTRU processing configuration may be associated with one maximum CPU assumption for one or a set of configured functions (e.g., transmit/collect/process AIML/sensing data).

For UL/DL WTRU processing for example, the WTRU may be configured with a plurality of WTRU processing configurations. A (e.g., each) WTRU processing configuration may be associated with one maximum CPU processing assumption and/or one set of HARQ processes for UL transmission and/or DL reception. The WTRU may be configured with one low WTRU processing configuration, which for example may include a low maximum CPU processing assumption and/or a small number of HARQ processes per UL/DL (e.g., 8 HARQ processes out of maximum 16 HARQ processes). The WTRU may be configured with another high WTRU processing configuration, which for example may include a high maximum CPU processing assumption and/or a maximum number of HARQ processes per UL/DL (e.g., 16 out of 16 HARQ processes).

For a WTRU processing configuration for example, the WTRU may be configured with three possible WTRU processing configurations. The WTRU may operate as a normal WTRU for the first WTRU processing configuration. The WTRU may operate as a RedCap WTRU for the second WTRU processing configuration. The WTRU may operate as an eRedCap WTRU for the third WTRU processing configuration.

For a WTRU processing configuration for example, the WTRU may be configured with two WTRU processing configuration. The first WTRU processing configuration may enable the WTRU to use a minimum WTRU processing capability. For example the first WTRU processing configuration may include one TRX, a 5 MHz bandwidth, large values of WTRU processing timeline (e.g., large values of K0, K2, Z), and/or no additional function/feature being enabled (e.g., AIML data collection, and/or positioning). The second WTRU processing configuration may enable the WTRU to use a maximum WTRU processing capability, for example where the WTRU processing configuration may include TRXs with maximum of 4 MIMO layer performing transmission/reception in all configured carriers with up to 400 MHz BWP, small values of WTRU processing timeline, and/or a maximum number QoS treatment profiles.

The WTRU may be (pre-)configured with a plurality of sets of WTRU processing configurations. The WTRU may be (pre-)configured with a multi-level WTRU processing configuration, for example where a (e.g., each) level of WTRU processing configuration may include different a configuration of one or more WTRU processing parameters. For a two level WTRU processing configuration for example, the WTRU may be configured with a plurality of sets of WTRU processing configurations where a set (e.g., each set) of WTRU processing configuration may include one or more WTRU processing configurations. For example for a three level WTRU processing configuration, the WTRU may be configured with a plurality of supersets of WTRU processing configurations, where for example a (e.g., each) superset of WTRU processing configurations may include one or more set of WTRU processing configurations and/or a (e.g., each) set of WTRU processing configuration may include one or more WTRU processing configurations.

For a two level WTRU processing configuration for example, the WTRU may be configured with a set of WTRU processing configurations. The set of WTRU processing configuration may include a WTRU processing configuration, which for example may not enable (e.g., require) the WTRU to perform any UL processing/transmission, DL processing/reception, and/or UL/DL processing. The WTRU may be configured with another set of WTRU processing configurations, for example which may enable the WTRU to perform DL reception in a carrier.

The set of WTRU processing configurations may include a configuration which may enable the WTRU to perform CSI-RS measurement reporting (e.g., only) and/or another configuration which may enable the WTRU to perform both CSI-RS measurement and control/data reception. The WTRU may be configured with another set of WTRU configurations, which for example may enable the WTRU to perform DL reception in two carriers (e.g., one anchor carrier and one data carrier). In this set of WTRU processing configurations for example, the WTRU may be configured with a WTRU processing configuration which may enable the WTRU to perform (e.g., only) CSI-RS measurement/reporting in the two carriers. The WTRU may be configured with another WTRU processing, which for example may enable the WTRU to perform CSI-RS measurement in both carrier and control/data in one carrier (e.g., anchor carrier). The WTRU may be configured with another WTRU processing configuration, which for example may enable the WTRU to perform both CSI-RS measurement/reporting and control/data reception in a plurality of (e.g. all) carriers.

Systems and methods may indicate/request the WTRU processing configuration. The WTRU may send an indication to the network. The indication may indicate a preferred WTRU processing configuration. The WTRU may additionally or alternatively send an indication indicating to the network information associated with the WTRU processing assumption, which for example may be referred to as WTRU processing configuration information (UPCI). The WTRU may indicate the information in the UPCI. The information may include one or more of a preferred set of WTRU processing configurations, a WTRU processing configuration to operate on, an indication of whether WTRU is ready to use a certain WTRU processing configuration and/or a certain value/range of one or more WTRU processing parameters, a WTRU processing status, and/or WTRU power consumption information.

The information may include a preferred set of WTRU processing configurations and/or a WTRU processing configuration to operate on. Additionally, or alternatively, the information may include a preferred value, a set of values, a range of values, and/or maximum/minimum value(s) associated with one or more WTRU processing parameters. The WTRU may be configured with a plurality of WTRU processing configurations. The WTRU may (e.g., then) send the indication to the network, for example regarding the preferred WTRU processing configuration to operate on. The WTRU may indicate to the network the preferred values of one or more WTRU processing parameters.

The information may include an indication of whether the WTRU is ready to use a (e.g., certain) WTRU processing configuration and/or a (e.g., certain) value/range of one or more WTRU processing parameters. The WTRU may be triggered to operate in one WTRU processing configuration (e.g., high WTRU processing configuration), for example for a certain service (e.g., URLLC, XR). The WTRU may (e.g., then) indicate to the network whether the triggered WTRU processing configuration may be used. If the WTRU processing configuration may not be used for example, the WTRU may indicate the preferred WTRU processing configuration to operate on.

The information may include a WTRU processing status, which for example may be used to indicate the information about a processing computation (e.g., the minimum/maximum/average) over a configured window. The WTRU may send a UPCI to indicate the percentage of a processing computation, for example compared to its maximum capability. For example, the WTRU may send UPCI to indicate the maximum/minimum/average number of RPUs/CPU-cores used in a configured window.

The information may include WTRU power consumption information (e.g., of the WTRU). The power consumption information reporting may be used by the network for a tradeoff between power consumption and data transmission/reception. The power consumption information reporting may be used by the network to know the energy consumption per WTRU processing configuration.

The WTRU may be configured with one WTRU processing configuration. The WTRU may (e.g., then) report power consumption information associated with the configured WTRU processing configuration. The WTRU may report the amount of consumed power per measurement quantity, for example where the measurement quantity may include one or more of a configured duration/window, a transmitted/received bit, and/or a (e.g., nominal) transmission/reception resource (e.g., an RE, 1 MHz in one slot). For example, the WTRU may report the amount of consumed power per configured duration, the amount of consumed power per transmitted/received bit, and/or the amount of consumed power per transmitted/received REs.

The WTRU may report an estimated/expected/measured power consumption per measurement quantity associated with a WTRU processing configuration. For example, the WTRU may report/indicate the WTRU processing configuration associated with the minimum/maximum power consumption per measurement quantity. The WTRU may report the estimated/expected/measured power consumption per measurement quantity for one or more (e.g., a set of) functions/features. For example, the WTRU may report the estimated/expected/measured power consumption per measurement quantity for AIML data collection. The WTRU may report an estimated/expected/measured sensing function.

The WTRU may determine a message to transmit/indicate the UPCI, for example to the network. The WTRU may send the UPCI to the network using one or more RCE messages. A (e.g., each) RCE message may be associated with PHY, MAC, RLC, PDCP, RRC, SDAP, and/or any new protocol layer. For example, the RCE message may be associated with UL-LP-WUS, DL-LP-WUS, DCI, UCI, MAC-CE, RLC control PDU, PDCP control PDU, RRC, and/or a control PDU from an introduced layer.

Systems and methods may include adaptation/determination of a WTRU processing configuration. The WTRU may determine which WTRU processing configuration to use. The WTRU may be configured with a plurality of WTRU processing configurations. For a (e.g., each) parameter associated with a WTRU processing configuration, the WTRU may be configured with a range of values, a set of values, a minimum value, a maximum value, and/or an exact value. For example, the WTRU may use a WTRU processing configuration (e.g., the first WTRU processing configuration) for uplink transmission and/or downlink reception. The WTRU may switch to another WTRU processing configuration.

The WTRU may change the value associated with one or more WTRU processing parameters. The WTRU may determine which set of WTRU processing configurations to use. The WTRU may determine which WTRU processing configuration to use. The WTRU may determine the value, set of values, range of values, and/or maximum/minimum value associated with one or more WTRU processing parameters (e.g., uplink WTRU processing/transmission, downlink WTRU processing/reception, and/or UL/DL WTRU processing). The WTRU may determine whether to trigger sending UPCI to the network.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on one or more of an explicit indication/configuration from the network, an implicit indication from the network, an implicit explicit request from the network, transmission of a (e.g., certain) type(s) of control/data/reference-signals, a buffer status of the WTRU, a data rate associated with uplink transmission and/or downlink reception, characteristic(s) associated with the traffic arrival of the WTRU, an availability/presence of one or more types of control/data/reference-signals, an observed data rate of one or more QoS flows/QoS treatment profiles, an expected arrival and/or arrival of a certain control/data/reference-signal for uplink transmission, reporting (e.g., in BSR), and/or downlink reception, a QoE associated with the service the WTRU is operating on, an absence of control/data received from the network for duration, expiry of a timer associated with WTRU processing configuration switching, channel condition(s) of the WTRU, a WTRU transmission power, a WTRU power condition, a WTRU heating condition, and/or a WTRU processing condition associated with one or more feature/function.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on an explicit indication/configuration from the network (e.g., for adapting the WTRU processing configuration). The WTRU may receive the indication from the network by one or more of LP-WUS, DCI, MAC-CE, RRC, and/or NAS message(s).

For example, the WTRU may operate in a WTRU processing configuration (e.g., a WTRU processing configuration associated with inactive mode). The WTRU may (e.g., then) receive an indication from the network (e.g., LP-WUS) to switch to another WTRU processing configuration (e.g., a WTRU processing capability associated to the active mode). The WTRU may (e.g., then) switch to the indicated WTRU processing configuration.

For example, the WTRU may receive an indication from the network to use 1Rx/1RF and/or monitor PDCCH, for intra carrier DCI scheduling, in the anchor carrier with the first PDCCH monitoring periodicity (e.g., sparse). The WTRU processing configuration may be used for a minimum monitoring in an anchor carrier with small data rate to be transmitted/received in the anchor carrier. For example, the WTRU may receive an indication from the network to use 1Rx/1RF and/or monitor PDCCH, for cross-carrier DCI scheduling of PDSCH/PUSCH in data carrier, in the anchor carrier with second PDCCH monitoring periodicity (e.g., dense). The WTRU processing configuration may be used for medium monitoring in an anchor carrier for medium data rate to be transmitted/received in the data carrier.

For example, the WTRU may receive an indication from the network to use 4Rx/4RF and/or monitor PDCCH, for intra carrier scheduling DCI, in the data carrier with the second PDCCH monitoring periodicity (e.g., dense). The WTRU processing configuration may be used for a high data rate to be transmitted/received in a data carrier. For example, the WTRU may receive an indication from the network to use 4Rx/4RF and/or monitor PDCCH, for multi-carriers scheduling DCI, with second PDCCH monitoring periodicity (e.g., dense) in both anchor and a plurality of data carriers. The WTRU processing configuration may be used for an extreme high data rate scenario.

The WTRU may be configured with a plurality of WTRU configurations. The WTRU may first operate in one WTRU processing configuration. The WTRU may (e.g., then) receive a DCI from the network to switch to another WTRU processing configuration. The WTRU may be configured with a field in the DCI to indicate the WTRU processing configuration, for example in which a (e.g., each) codepoint may be associated with one WTRU processing configuration. The WTRU may (e.g., then) determine which WTRU processing configuration to operate on based on the codepoint received from the network. The WTRU may be configured with one or more WTRU processing configuration fields in a DCI, for example in which a (e.g., each) field may be used to indicate one or more parameters associated with a WTRU processing configuration. The WTRU may (e.g., then) determine the WTRU processing configuration to use based on the combination of the codepoints indicated in each field.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on an implicit indication from the network (e.g., a DCI, a PDSCH, a MAC-CE, an RRC, a TB). For example, the WTRU may initially operate in a low data rate WTRU processing configuration with high values of processing time for control/data/reference-signal (e.g., N1, N2, Z, K0, K1, and/or K2). The WTRU may (e.g., then) receive an indication (e.g., DCI, LP-WUS, MAC-CE) from the network to switch to high data rate WTRU processing configuration. The WTRU may (e.g., then) switch to a high data rate WTRU processing configuration with small values of processing time for control/data/reference-signal.

For example, the WTRU may first use one 1Rx/1RF to monitor PDCCH from the network (e.g., in an anchor carrier). The WTRU may (e.g., then) switch to 4Rx/4RF in the subsequent monitoring occasions, for example if the WTRU detects a DCI scheduling (e.g., a DCI schedules PDSCH and/or PUSCH) from the network.

For example, the WTRU may first use one 1Rx/1RF to monitor PDCCH from the network (e.g., in an anchor carrier). The WTRU may (e.g., then) switch to 4Rx/4RF in the subsequent monitoring occasions, for example if the WTRU decodes a TB containing the data associated with a service (e.g., XR service). The WTRU may determine data associated with a service based on the received DRB/LCH/QoS-flow, which for example may be configured to the service. The WTRU may use smaller values of processing time for control/data/reference-signal (e.g., N1, N2, Z, K0, K1, and/or K2), for example if the WTRU receives data associated with the XR service. The WTRU may (e.g., therefore) increase processing capability to receive an upcoming high data rate.

For example, the WTRU may first send UPCI to the network to request a preferred (set of) WTRU processing configuration and/or a preferred value, set of values, range of values, and/or maximum/minimum values associated with one or more WTRU processing parameters to operate on. The WTRU may (e.g., then) receive an acknowledgement from the network (e.g., via DCI, LP-WUS). The WTRU may (e.g., then) operate in the reported/requested (e.g., set of) WTRU processing configuration(s), for example upon reception of acknowledgement from the network.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on an implicit/explicit request from the network (e.g., for sending UPCI).

For example, the WTRU may receive a request from the network to inquire about a WTRU processing status. The WTRU may (e.g., then) respond to the request, for example by sending UPCI to the network. For example, the WTRU may receive an implicit/explicit indication from the network to switch to another WTRU processing configuration. The WTRU may (e.g., then) send UPCI to the network, which for example may be used to indicate whether the WTRU is ready to use the indicated WTRU processing configuration.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on transmission of a (e.g., certain) type(s) of control/data/reference-signal(s) (e.g., e.g., UL-LP-WUS, UCI, SR, BSR, MAC-CE, PUCCH, PUSCH, SRS, and/or SRSp, reference signal for sensing). For example, the WTRU may first operate in one WTRU processing configuration (e.g., low WTRU processing configuration). The WTRU may (e.g., then) switch to another WTRU processing configuration (e.g., high WTRU processing configuration), for example if the WTRU transmits SR/BSR/DSR to the network. The SR/BSR/DSR may be used to indicate the availability of data associated with stringent QoS (e.g., high-priority data, low-latency data, and/or high-volume data).

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the buffer status of the WTRU.

For example, the WTRU may determine the WTRU processing configuration to be used based on the amount of data and/or QoS associated with the data in the buffer. The WTRU may use low WTRU processing configuration (e.g., the WTRU processing configuration with large values of K0, K1, K2, small number of active antennas, RF chains, and/or MIMO layers), for example if the amount of data in the buffer is smaller than a configured threshold. If the amount of data in the buffer is larger than a configured threshold for example, the WTRU may use high WTRU processing capability (e.g., the WTRU processing configuration with small values of K0, K1, K2, large number of active antennas, RF chains, and/or MIMO layers).

The WTRU may trigger sending UPCI to the network based on the buffer status of the WTRU, for example for sending UPCI to the network. For example, the WTRU may be configured with a set of possible WTRU processing configurations associated with a service (e.g., XR/URLLC). The WTRU may indicate to the network a preferred WTRU processing configurations to operate on, for example when data associated with the service arrives. The preferred WTRU processing configuration(s) may be from the set of configurations associated with the service. For example, the WTRU may be configured with a set of possible WTRU processing configurations associated with the amount of data in the buffer. The WTRU may (e.g., then) trigger sending the preferred WTRU processing configuration and/or an indication of whether the WTRU is ready to use the configured WTRU processing configuration, for example based on the amount of data in the buffer.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the data rate associated with uplink transmission and/or downlink reception. The uplink data rate may be determined based on the buffer status of the WTRU and/or an expected data arrival of the WTRU. The downlink data rate may be determined based on an indication from the network for example.

For example, the WTRU may receive an indication from the network regarding the upcoming data rate. The WTRU may (e.g., then) determine which WTRU processing configuration to use, for example based on the indicated upcoming data rate from the network. The WTRU may use a WTRU processing configuration (e.g., WTRU processing configuration associated with large value of K0/K1/K2, small number TRX antennas, MIMO layer) for a small upcoming data rate. Additionally, or alternatively, the WTRU may use another WTRU processing configuration (e.g., WTRU processing configuration associated with small value of K0/K1/K2, large number TRX antennas, MIMO layers) for a large upcoming data rate.

For example, the WTRU may use small number of RPUs (e.g., using one anchor RPU) for a small upcoming data rate. Additionally, or alternatively, the WTRU may use large number of RPUs (e.g., one anchor RPU and one or more data RPUs) for a large upcoming data rate.

For example, the WTRU may be configured with one or more WTRU processing configuration associated with a range of data rates. The WTRU may (e.g., then) trigger sending the preferred WTRU processing configuration and/or an indication of whether the WTRU is ready to use the configured WTRU processing configuration based on the change in the data rate, for example for which the WTRU may adapt the WTRU processing capability.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the characteristics associated with the traffic arrival of the WTRU (e.g., whether the data arrival is bursty or not).

The WTRU may switch to another WTRU processing configuration (e.g., high WTRU processing configuration), for example if bursty data arrives. The WTRU may be configured to determine whether bursty data arrives, for example based on whether the amount of data arrived within a period is greater than a configured threshold or not. If the amount of data arrived within a configured duration is greater than a configured threshold for example, the WTRU may determine that the data arrival is bursty and/or may use the configured WTRU processing configuration (e.g., high WTRU processing). The WTRU may (e.g., otherwise) keep the same WTRU processing configuration.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the availability/presence of one or more types of control/data/reference-signals (e.g., PDCCH/PDSCH) from the network.

For example, the WTRU may first operate in one WTRU processing configuration (e.g., a low WTRU processing assumption with 1 Rx antennas and large values of K0, K2) for PDCCH monitoring. The WTRU may (e.g., then) switch to another WTRU processing configuration (e.g., high WTRU processing assumption with 4Rx antennas and small values of K0, K2) for subsequent PDCCH monitoring occasions, for example if the WTRU detects a PDCCH from the network. The WTRU processing configuration switching may be additionally or alternatively based on the configured parameters indicated in the PDCCH. For example, the WTRU may switch to a high WTRU processing configuration if the WTRU detects a DCI scheduling PDSCH. For example, the WTRU may switch to a high WTRU processing configuration if the WTRU detects a DCI scheduling a plurality of PDSCHs. The WTRU may keep the same WTRU processing configuration for PDCCH monitoring, for example if the WTRU detects DCI to schedule aperiodic SRS and/or aperiodic CSI reporting. The WTRU may be enabled to switch to a different WTRU processing configuration, for example if the WTRU should change the WTRU processing assumption (e.g., to receive much more data).

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the observed data rate of one or more QoS flows/QoS treatment profiles. For example, the WTRU may be configured with one or more WTRU processing configuration associated with a range of observed data rates. The WTRU may (e.g., then) determine which WTRU processing configuration to use based on the observed data rate, for example within a configured duration.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the expected arrival and/or arrival of a certain control/data/reference-signal for uplink transmission, reporting (e.g., in BSR), and/or downlink reception. The WTRU may determine the WTRU processing configuration and/or the value associated with one or more parameters of a (e.g., each) WTRU processing configuration based on one or more events related to arrival of control/data/reference-signal.

The one or more events may include an expected arrival and/or arrival of data from a configured set of QoS flows, an expected arrival and/or arrival of data from a set of QoS treatment profiles, an expected arrival and/or the arrival of data associated with a service, an expected arrival and/or the arrival of data associated with a plane, an expected arrival and/or the arrival of a new data type, availability of data associated with certain QoE/QoS parameters, and/or an expected arrival and/or the arrival of an amount of data associated with a set of QoS flows, set of QoS treatment profiles, a set of services, a data plane, the user plane, and/or the buffer of the WTRU.

The one or more events may include the expected arrival and/or arrival of data from a configured set of QoS flows. For example, the WTRU may be configured with an association between the WTRU processing configuration and the associated QoS flows. The WTRU may (e.g., then) determine which WTRU processing configuration to operate on based on the expected arrival and/or arrival of the data in a QoS flow. If the data is associated with a high-priority/low-latency QoS flow(s) for example, the WTRU may use a high WTRU processing configuration. If the data is associated with low-priority/delay-tolerance QoS flow(s) for example, the WTRU may use a low WTRU processing configuration.

The one or more events may include the expected arrival and/or arrival of data from a set of QoS treatment profiles (e.g., a set of DRBs/LCHs). For example, the WTRU may be configured with an association between the WTRU processing configuration and an QoS treatment profile (e.g., DRB/LCH). The WTRU may (e.g., then) determine which WTRU processing configuration to operate based on the expected arrival and/or arrival of the data in a QoS treatment profile (e.g., DRB/LCH).

The one or more events may include the expected arrival and/or the arrival of data associated with a service (e.g., XR, URLLC, eMBB, AIML, sensing services). For example, the WTRU may be configured with an association between the WTRU processing configuration and a service (e.g., XR, URLLC, eMBB, AIML). The WTRU may (e.g., then) determine which WTRU processing configuration to use based on the service associated with the expected arrival and/or arrival of the data. If the data is associated with a XR/URLLC services for example, the WTRU may use high WTRU processing configuration. If the data is associated with eMBB service for example, the WTRU may use a medium WTRU processing configuration. If the data is associated with AIML service for example, the WTRU may use a low WTRU processing configuration.

For example, the WTRU may trigger sending UPCI to the network. The UPCI may indicate a preferred WTRU processing configuration and/or whether the WTRU is ready to operate in the WTRU processing configuration (e.g., high WTRU processing configuration with intensive computation), for example upon the expected arrival and/or arrival of data associated with the XR service.

The one or more events may include the expected arrival and/or the arrival of data associated with a plane (e.g., data plane for AIML, sensing). For example, the WTRU may be configured with a data plane to convey AIML/sensing data. The WTRU may use a configured processing WTRU processing configuration to treat the data associated with the data plane. The WTRU may (e.g., then) use the configured WTRU processing configuration to handle the data associated with the data plane, for example when data associated with the data plane is received.

The one or more events may include the expected arrival and/or the arrival of a new data type, for example where a data type may be associated with new services provided by a system (e.g., 6G) such as computing as a service, AI/ML (e.g. data training, monitoring data, inference, AI/ML models or algorithm) as a service. For example, the WTRU may use a configured WTRU processing configuration to forward the data associated with a (e.g., each of the) new service(s). The WTRU may (e.g., then) use the configured WTRU processing configuration to handle the data associated with the new service, for example when data associated with the new service is received.

The one or more events may include the availability of data associated with certain QoE/QoS parameters (e.g., the availability of delay-critical data, high-importance data, high-priority data). For example, the WTRU may be configured with a WTRU processing configuration for the data having a certain QoE/QoS value. The WTRU may (e.g., then) use the configured WTRU processing configuration, for example if the data associated with the certain QoE/QoS value is available. For example upon having delay-critical data (e.g., after transmission of DSR), the WTRU may switch the WTRU processing configuration having small values of K0/K1/K2. The processing configuration may enable the network to accelerate the scheduling of delay-critical data.

For example, the WTRU may operate in a non-active period for downlink reception (e.g., WTRU may disable PDCCH monitoring). The WTRU may be configured with two WTRU processing configurations for uplink processing/transmission, for example where one WTRU processing configuration may enable the WTRU to perform one or more types of UL transmission (e.g., SR) during the non-active period and/or another WTRU processing configuration may disable the WTRU to perform one or more types of UL transmission (SR). The WTRU may (e.g., then) determine which uplink processing/transmission configuration to operate based on the availability of delay-critical/high-priority/importance data in the buffer. If the WTRU has delay-critical/high-priority/importance data in the buffer for example, the WTRU may select the WTRU processing configuration enabling the WTRU to transmit SR during non-active time. If there is no delay-critical/high-priority/importance data in the buffer for example, the WTRU may not transmit SR during non-active time. For example, the WTRU may wait until the active period to transmit SR.

The one or more events may include the expected arrival and/or the arrival of an amount of data associated with a set of QoS flows, set of QoS treatment profiles, a set of services, a data plane, the user plane, and/or the buffer of the WTRU. Any event herein may be additionally or alternatively based on an amount of data, which for example may trigger the event(s).

For example, the WTRU may first operate in one WTRU processing configuration (e.g., low WTRU processing configuration). The WTRU may switch to another WTRU processing configuration (e.g., high WTRU processing configuration), for example if the amount of delay-critical data is greater than a configured threshold. The WTRU may switch to another WTRU processing configuration (e.g., high WTRU processing configuration), for example if the amount of data associated with URLLC/XR services is greater than a configured threshold. The WTRU may switch to another WTRU processing configuration (e.g., high WTRU processing configuration), for example if the amount of data associated with high-priority DRBs/LCHs is greater than a configured threshold.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the QoE associated with the service the WTRU is operating on. For example, the WTRU may be configured with a plurality of WTRU processing configurations. A (e.g., each) WTRU processing configuration may be associated with a QoE of the service. The WTRU may (e.g., then) determine which WTRU processing configuration to use based on the QoE of the service.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the absence of control/data received from the network for a duration.

For example, the WTRU may initially operate in a high WTRU processing configuration (e.g., using 4TRx antennas for PDCCH monitoring, using small PDCCH monitoring periodicity in a large CORESET). The WTRU may (e.g., then) switch to another WTRU processing configuration (e.g., using 1 TRx antenna for PDCCH monitoring, using large PDCCH monitoring periodicity in a small CORESET), for example if the WTRU does not receive DCI from the network after a configured duration.

For example, the WTRU may initially operate in a high WTRU processing configuration (e.g., monitoring PDCCH in a plurality of carriers including both anchor carrier and a plurality of data carriers). The WTRU may (e.g., then) switch to another WTRU processing configuration (e.g., monitoring PDCCH in one anchor carrier only), for example if the WTRU does not receive DCI from the network after a configured duration.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the expiry of a timer associated with WTRU processing configuration switching.

The WTRU may first operate in high WTRU processing configuration, for example where the WTRU may monitor dense PDCCH in data carrier. The WTRU may (e.g., then) switch to spare PDCCH monitoring periodicity, for example if a timer expires. The timer may be started when no DCI is detected in a PDCCH monitoring occasion. The timer may be reset when a DCI is detected for example.

The WTRU may first operate in high WTRU processing configuration, for example where the WTRU may monitor dense PDCCH in a data carrier. The WTRU may (e.g., then) stop monitoring PDCCH in a CORESET associated with the data carrier and/or switch to monitor PDCCH in a CORESET associated with the anchor carrier, for example if the timer expires.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the channel condition(s) of the WTRU. The channel condition(s) may include a channel condition and/or a change in the channel condition.

The channel condition(s) may include the channel condition (e.g., SINR, RSRP, RSRQ, RSSI). For example, the WTRU may operate in one WTRU processing configuration. The WTRU may be configured to switch to another WTRU processing configuration, for example if the channel condition satisfied a condition (e.g., the RSRP is greater/smaller than a configured threshold). The channel condition(s) may include a change in the channel condition. For example, the WTRU may operate in one WTRU processing configuration. The WTRU may be configured to switch to another WTRU processing configuration, for example if the change in the channel condition (e.g., RSRP change) within a period is larger than a configured threshold.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the WTRU transmission power. For example, the WTRU may trigger sending UPCI to the network. The UPCI may be used to indicate its preferred lower WTRU processing configuration (e.g., lower maximum transmission bandwidth, lower number of aggregated frequency-blocks, lower number of MIMO layers), for example if the transmission power of the WTRU in one or more previous transmission is greater than or equal to a configured threshold.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the WTRU power condition. For example, the WTRU may trigger sending the UPCI to the network. The UPCI may be used to reduce the WTRU processing configuration, for example if the remaining battery is smaller than a configured threshold.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the WTRU heating condition. For example, the WTRU may trigger sending UPCI to the network. The UPCI may be used to indicate the preferred WTRU processing configuration (e.g., a lower WTRU processing configuration), for example if the overheating condition is satisfied.

The WTRU may determine (e.g., determining which set of WTRU processing configurations to use, which WTRU processing configuration to use, determining the value, set of values, range of values, and/or maximum/minimum value associated with one or more WTRU processing parameters associated with the WTRU processing configuration, and/or sending UPCI to the network) based on the WTRU processing condition associated with one or more feature/function. The WTRU may disable one or more feature/function (e.g., DL-PRS measurement), for example if the WTRU processing associated with one or more other feature/function (e.g., AIML inference) is greater than a configured threshold.

The WTRU may be configured with two WTRU processing configurations, for example where a (e.g., each) WTRU processing configuration may be associated with a set of WTRU processing value (e.g., minimum gap between PDCCH and PDSCH/PUSCH). The WTRU may use the first set of WTRU processing value, for example if the WTRU has data associated with a URLLC service and/or has reported to the network via BSR.

The WTRU may determine the WTRU processing configuration to use based on the arrival of the bursty data and/or the QoS associated with the bursty data. The WTRU may be configured with three WTRU processing configurations, for example where the WTRU may use the first WTRU processing configuration (e.g., minimum WTRU processing configuration) if there is no bursty data arrival. The WTRU may use the second WTRU processing configuration (e.g., medium WTRU processing configuration with large values of WTRU processing timeline (e.g., K0, K2), for example if the bursty data is associated with delay tolerance service. The WTRU may (e.g., then) use the third WTRU processing configuration (e.g., intensive WTRU processing configuration with small value of WTRU processing timeline), for example if the bursty traffic is associated with delay-critical services.

The WTRU may determine to use another WTRU processing configuration based on the triggering condition for using the WTRU processing configuration being satisfied. The WTRU may send an indication to the network indicating whether the WTRU is ready to use the WTRU processing configuration, for example upon using the other WTRU processing configuration.

The WTRU may be configured with a plurality of WTRU processing configurations. A (e.g., each) WTRU processing configuration may include a set of WTRU processing parameters for UL processing, DL processing, and/or UL/DL WTRU processing.

A (e.g., each) WTRU processing configuration may include a set of WTRU processing parameters for DL WTRU processing/reception. One WTRU processing configuration may enable the WTRU to use 1Rx/1RF and/or monitor PDCCH in an anchor cell with the first PDCCH monitoring periodicity (e.g., sparse). Another WTRU processing configuration may enable the WTRU to use 4Rx/4RF and/or monitor PDCCH in all carriers/cells with the second PDCCH monitoring periodicity.

A (e.g., each) WTRU processing configuration may include a set of WTRU processing parameters for UL WTRU processing/transmission. A WTRU processing configuration may enable the WTRU to use Tx/RF antennas for UL transmission in anchor cell. Another WTRU processing configuration may enable the WTRU to use (e.g., all) 4Tx/RF for uplink transmission in (e.g., both) anchor and/or a plurality of data carriers.

A (e.g., each) WTRU processing configuration may include a set of WTRU processing parameters for UL/DL WTRU processing. A profile may be associated with small number of HARQ process IDs and/or large values of the minimum gap between DCI and PDSCH/PUSCH (e.g., K0, K2) and/or between CSI-RS and CSI reporting (e.g., Z). Another profile may be associated with large number of HARQ process IDs and/or small values of the minimum gap between DCI and PDSCH/PUSCH (e.g., K0, K2) and/or between CSI-RS and CSI reporting (e.g., Z).

There may be one or more triggering conditions to apply each WTRU processing configuration. The one or more triggering conditions may include an indication from the network, a configuration between one or more WTRU processing configuration and a service, and/or when an amount of data in the buffer is greater than a configured threshold. The indication from the network may be sent/received using LP-WUS, DCI, MAC-CE, and/or RRC. The one or more triggering conditions may include a configuration between one or more WTRU processing configurations and a service (e.g., the availability of data in a configured set of QoS flows). For example a (e.g., each) WTRU processing configuration of a service may be associated with one QoS flow to DRB mapping. A (e.g., each) processing configuration of a service may be associated with one QoS flow of the set of QoS flows associated with the service.

The WTRU may operate in a first WTRU processing configuration (e.g., low power/intensity WTRU processing configuration, which may enable the WTRU to use one Rx to monitor spare PDCCH). The WTRU may determine to use a second WTRU processing configuration (e.g., high power/intensity WTRU processing configuration, which may enable the WTRU to use 4Rx to monitor dense PDCCH), for example when the triggering condition to use the second WTRU processing configuration is satisfied. The triggering condition may include one or more of when the WTRU receives indication from the network to switch to the second WTRU processing configuration, when data associated with XR/URLLC service arrives, and/or when the amount of data in the buffer is greater than a configured threshold.

The WTRU may send WTRU processing configuration information (UPCI), for example to the network. The UPCI may indicate the WTRU preferred WTRU processing configuration and/or whether the WTRU is ready to use a WTRU processing configuration associated with a service (e.g., XR/URLLC). The WTRU may operate in the second WTRU processing configuration (e.g., high power/intensity WTRU processing configuration, which may enable the WTRU to use 4Rx/4RF and monitor PDCCH in all configured carriers/cells with the dense PDCCH monitoring periodicity). Systems and methods may enable the WTRU to (e.g., quickly) adapt the WTRU processing configuration, for example to minimize the WTRU processing and/or minimize the impact on QoS/QoE degradation and/or the impact on network scheduling flexibility.

1. A wireless transmit/receive unit (WTRU) comprising:
a processor configured to:
receive, from a network, configuration information, wherein the configuration information comprises a plurality of processing configurations, wherein each processing configuration of the plurality of processing configurations comprises at least one parameter for at least one or more of uplink (UL) processing or downlink (DL) processing, and wherein the configuration information comprises an indication of at least one triggering condition associated with at least one of the plurality of processing configurations;
operate in accordance with a first processing configuration of the plurality of processing configurations;
determine to operate in a second processing configuration of the plurality of processing configurations based on the at least one triggering condition being met;
send an indication of the second processing configuration to the network; and
operate in accordance with the second processing configuration.

2. The WTRU of claim 1, wherein the indication of the second processing configuration indicates that the second processing configuration is a preferred processing configuration.

3. The WTRU of claim 2, wherein the processor is configured to determine that the second processing configuration is the preferred processing configuration based on at least one preferred value associated with the at least one parameter.

4. The WTRU of claim 1, wherein the processor is configured to send the indication of the second processing configuration to the network in at least one radio control element message, the radio control element message associated with at least one control element.

5. The WTRU of claim 1, wherein the at least one triggering condition comprises an amount of data in a buffer exceeding a threshold amount.

6. The WTRU of claim 1, wherein the at least one triggering condition comprises an indication from the network to operate in accordance with the second processing configuration.

7. The WTRU of claim 1, wherein the second processing configuration is associated with a service, wherein the at least one triggering condition associated with each of the plurality of processing configurations comprises reception of data associated with the service.

8. The WTRU of claim 1, wherein the first processing configuration is associated with a first quality of service and the second processing configuration is associated with a second quality of service, and wherein the at least one triggering condition comprises reception of data associated with the second quality of service.

9. The WTRU of claim 1, wherein the processor is configured to:
send a request to the network to operate in accordance with the second processing configuration; and
receive a response indicating that the WTRU should operate in accordance with the second processing configuration.

10. The WTRU of claim 1, wherein the processor is configured to:
operate in accordance with a third processing configuration based on the at least one triggering condition; and
switch from a first carrier to a second carrier to operate in the third processing configuration.

11. A method performed by a wireless transmit/receive unit (WTRU), the method comprising:
receiving, from a network, configuration information, wherein the configuration information comprises a plurality of processing configurations, wherein each processing configuration of the plurality of processing configurations comprises at least one parameter for at least one or more of uplink (UL) processing or downlink (DL) processing, and wherein the configuration information comprises an indication of at least one triggering condition associated with at least one of the plurality of processing configurations;
operating in accordance with a first processing configuration of the plurality of processing configurations;
determining to operate in a second processing configuration of the plurality of processing configurations based on the at least one triggering condition being met;
sending an indication of the second processing configuration to the network; and
operating in accordance with the second processing configuration.

12. The method of claim 11, wherein the indication of the second processing configuration indicates that the second processing configuration is a preferred processing configuration.

13. The method of claim 12, comprising determining that the second processing configuration is the preferred processing configuration based on at least one preferred value associated with the at least one parameter.

14. The method of claim 11, comprising sending the indication of the second processing configuration to the network in at least one radio control element message, the radio control element message associated with at least one control element.

15. The method of claim 11, wherein the at least one triggering condition comprises an amount of data in a buffer exceeding a threshold amount.

16. The method of claim 11, wherein the at least one triggering condition comprises an indication from the network to operate in accordance with the second processing configuration.

17. The method of claim 11, wherein the second processing configuration is associated with a service, wherein the at least one triggering condition associated with each of the plurality of processing configurations comprises reception of data associated with the service.

18. The method of claim 11, wherein the first processing configuration is associated with a first quality of service and the second processing configuration is associated with a second quality of service, and wherein the at least one triggering condition comprises reception of data associated with the second quality of service.

19. The method of claim 11, comprising:
sending a request to the network to operate in accordance with the second processing configuration; and
receiving a response indicating that the WTRU should operate in accordance with the second processing configuration.

20. The method of claim 11, comprising:
operating in accordance with a third processing configuration based on the at least one triggering condition; and
switching from a first carrier to a second carrier to operate in the third processing configuration.
